(19) United States
(12) Patent Application Publication
(10) Pub. No.: US 2016/0241787 A1
(43) Pub. Date: Aug. 18, 2016

(54) CAMERA MODULE

(71) Applicant: SHARP KABUSHIKI KAISHA, Osaka-shi, Osaka (JP)

(72) Inventor: Yoshihiro SEKIMOTO, Osaka-shi, Osaka (JP)

(21) Appl. No.: 15/024,363

(22) PCT Filed: Jun. 24, 2014
(86) PCT No.: PCT/JP2014/066692

§ 371 Date: Mar. 24, 2016

(30) Foreign Application Priority Data
Sep. 27, 2013 (JP) 2013-202478
Mar. 19, 2014 (JP) 2014-056726

(51) Int. Cl. H04N 5/232; G02B 27/64; G02B 7/09

(52) U.S. Cl. CPC H04N 5/23287; H04N 5/23212; G02B 7/09; G02B 27/646

(57) ABSTRACT

The camera module (100) includes an AF movable section, an OIS movable section, an AF fixed section, an OIS fixed section, an AF driving section (37), an OIS driving section (38), an AF displacement detecting section (31), and an OIS displacement detecting section (34).

### TECHNICAL FIELD

The present invention relates to a camera module mounted on an electronic device such as a mobile phone. Specifically, the present invention relates to a camera module having an image stabilization function.

### BACKGROUND ART

On the recent mobile phone market, models of mobile phones having built-in camera modules have become dominant. These camera modules to be mounted on mobile phones need to be housed in the mobile phones. Therefore, the camera modules face greater demands for reduction in size and weight, as compared with camera modules to be mounted on digital cameras.

Moreover, there have been an increasing number of camera modules that (i) achieve their autofocus (AF) functions with the use of lens drive devices and (ii) are mounted on electronic devices such as mobile phones. Various types of lens drive devices have been developed so far, and examples of the lens drive devices encompass those employing stepper motors, those employing piezoelectric elements, and those employing Voice Coil Motors (VCM). Such lens drive devices have already been distributed on the market. For example, Patent Literature 1 discloses a camera module including a position detecting section for detecting a position of a lens barrel which is displaced for autofocusing. The camera module compares position information detected by the position detecting section with a target position in focusing, and controls displacement of the lens barrel in driving the lens barrel so that the lens barrel will reach the target position.

Meanwhile, in such a circumstance that the camera module having the autofocus function has become standard, the image stabilization function has been attracting attention as another feature for differentiation of camera modules. Although the image stabilization function is widely employed in digital cameras, camcorders, etc., there have still been only a few mobile phones employing the image stabilization function, due to their limited sizes. Nevertheless, mobile-phone-specified camera modules having the image stabilization function are expected to increase in the future, and, in fact, there have been an increasing number of proposals on a novel structure of an image stabilization mechanism which allows for reduction in size.

Patent Literature 2 discloses, as an image stabilization mechanism, an image stabilizer employing a “barrel shift system”. The image stabilizer disclosed in Patent Literature 2 is an image stabilizer that stabilizes an image by (i) moving an entire auto-focusing lens drive section or a movable section thereof in a first direction and a second direction which are perpendicular to an optical axis and are perpendicular to each other, and (ii) thereby moving a lens barrel along the optical axis, the auto-focusing lens drive section being provided with a focusing coil and a permanent magnet which is disposed radially outside the focusing coil with respect to the optical axis so as to face the focusing coil. The image stabilizer disclosed in Patent Literature 2 includes: a base disposed to be spaced from the bottom surface of the auto-focusing lens drive section; a plurality of suspension wires; and an image stabilizing coil disposed to face the permanent magnet. The plurality of suspension wires each have one end fixed to the outer peripheral section of the base and extend along the optical axis. The plurality of suspension wires also support the entire auto-focusing lens drive section or the movable section thereof in such a manner that the auto-focusing lens drive section can rock in the first direction and the second direction. The auto-focusing lens drive section includes a lens holder having a tubular section for holding the lens barrel, while the focusing coil is fixed to a position on the periphery of the tubular section of the lens holder.

### CITATION LIST

### Patent Literature

### [Patent Literature 1]

Japanese Patent Application Publication, Tokukai, No. 2011-197626 (Publication date: Oct. 6, 2011)

### [Patent Literature 2]

Japanese Patent Application Publication, Tokukai, No. 2011-65140 (Publication date: Mar. 31, 2011)

### SUMMARY OF INVENTION

### Technical Problem

However, the camera module disclosed in Patent Literature 1 has only an autofocus function and is merely configured to detect displacement in autofocusing. Patent Literature 1 mentions nothing about image stabilization.

Meanwhile, though the image stabilization device disclosed in Patent Literature 2 has an image stabilization function, the image stabilization device does not have an autofocus displacement detecting function. Note that though the base is provided with a displacement detecting element, this displacement detecting element cannot be used as a displacement detecting element for detection of a displacement in an autofocus direction. This is because this displacement detecting element is intended to detect a displacement of an intermediate retainer in an image stabilization direction, which intermediate retainer is a fixed portion in an autofocus and is not displaced in the autofocus direction. Accordingly, in a case where a pulse current is applied so that an autofocus movable section will be driven to a target position, an overshoot occurs in accordance with the vibration theory. This is because no misalignment can be detected even in a case where the autofocus movable section moves beyond the target position. As a result, transient vibration occurs. This results in a problem that a lot of time is needed for returning the autofocus movable section back to the target position. Further, there is no displacement detecting element for detection in the autofocus direction, and accordingly, displacement detection in the autofocus direction is not possible. This causes a problem that it is not possible to verify whether the autofocus movable section has moved as intended, so that the accuracy of displacement control in the autofocus direction cannot be enhanced.

The present invention is made in view of the above problems and the object of the present invention is to provide a camera module having an autofocus function and an image stabilization function, which camera module allows for feedback control of autofocusing and image stabilization and thereby achieves highly-accurate and high-speed autofocusing and image stabilization.

### Solution to Problem

In order to attain the above object, a camera module in accordance with an aspect of the present invention is a camera module including: an image stabilization fixed section including: an image capturing element; an image stabilization movable section including: an image capturing lens; an autofocus fixed section; and an autofocus movable section; an autofocus displacement detecting section; an image stabilization displacement detecting section; an image stabilization driving section; and an autofocus driving section, the image capturing element having an axis corresponding to an optical axis of the image capturing lens, the image stabilization fixed section being not displaced in any direction, the image stabilization movable section being displaced, by the image stabilization driving section, in two directions which are each perpendicular to the optical axis and which are perpendicular to each other, with respect to the image stabilization fixed section, the autofocus fixed section being not displaced in a direction of the optical axis, the autofocus movable section being displaced, by the autofocus driving section, in the direction of the optical axis with respect to the autofocus fixed section, the autofocus displacement detecting section detecting displacement of the autofocus movable section in the direction of the optical axis, the image stabilization displacement detecting section detecting displacement of the image stabilization movable section in the two directions which are each perpendicular to the optical axis and which are perpendicular to each other.

### Advantageous Effects of Invention

According to an aspect of the present invention, it is possible to advantageously provide a camera module having an autofocus function and an image stabilization function, which camera module allows for feedback control of autofocusing and image stabilization and thereby achieves highly-accurate and high-speed autofocusing and image stabilization.

### BRIEF DESCRIPTION OF DRAWINGS

FIG. 1 is a perspective view schematically illustrating a configuration of a camera module in accordance with Embodiment 1 of the present invention.

FIG. 2 is a cross-sectional view illustrating the camera module illustrated in FIG. 1, viewed along arrows A-A.

FIG. 3 is a cross-sectional view illustrating the camera module illustrated in FIG. 1, viewed along arrows B-B.

FIG. 4 is a block diagram illustrating example control blocks of the camera module illustrated in FIG. 1.

FIG. 5 is a view schematically illustrating a state where an elastic body and a suspension wire of the camera module illustrated in FIG. 1 are connected to each other.

(a) of FIG. 6 is a view schematically illustrating an example configuration of the elastic body and a damper member of the camera module illustrated in FIG. 1. (b) of FIG. 6 is a view schematically illustrating another example configuration of the elastic body and the damper member of the camera module illustrated in FIG. 1.

FIG. 7 is a view schematically illustrating further another example configuration of the elastic body and the damper member of the camera module illustrated in FIG. 1.

FIG. 8 is a view schematically illustrating still further another example configuration of the elastic body and the damper member of the camera module illustrated in FIG. 1.

FIG. 9 is a Bode diagram illustrating an example frequency characteristic of movement in an image stabilization direction during servo driving for image stabilization in the camera module illustrated in FIG. 1.

FIG. 10 is a perspective view schematically illustrating a configuration of a camera module in accordance with Embodiment 2 of the present invention.

FIG. 11 is a cross-sectional view schematically illustrating a configuration of a camera module in accordance with Embodiment 3 of the present invention.

FIG. 12 is a cross-sectional view schematically illustrating a configuration of a camera module in accordance with Embodiment 4 of the present invention.

FIG. 13 is a cross-sectional view illustrating the camera module illustrated in FIG. 12, viewed along arrows D-D.

(a) of FIG. 14 is a view illustrating an example in which (i) no AF displacement detection magnet is provided and (ii) an AF Hall element is provided so as to face a combined magnet. (b) of FIG. 14 is a view illustrating an example in which (i) an AF displacement detection magnet is provided and (ii) a magnetic flux density detecting element of an AF Hall element is provided so as to face the AF displacement detection magnet.

FIG. 15 is a cross-sectional view schematically illustrating a configuration of a camera module in accordance with Embodiment 5 of the present invention.

FIG. 16 is a cross-sectional view illustrating the camera module illustrated in FIG. 15, viewed along arrows E-E.

FIG. 17 is a cross-sectional view schematically illustrating a configuration of a camera module in accordance with Embodiment 6 of the present invention.

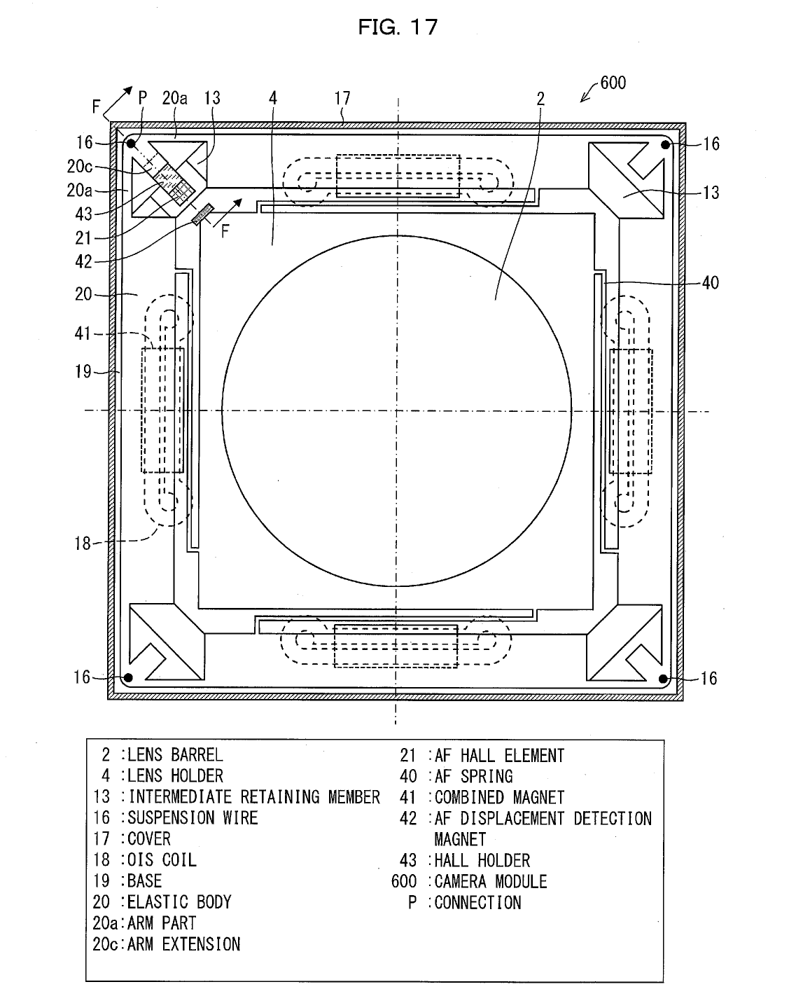

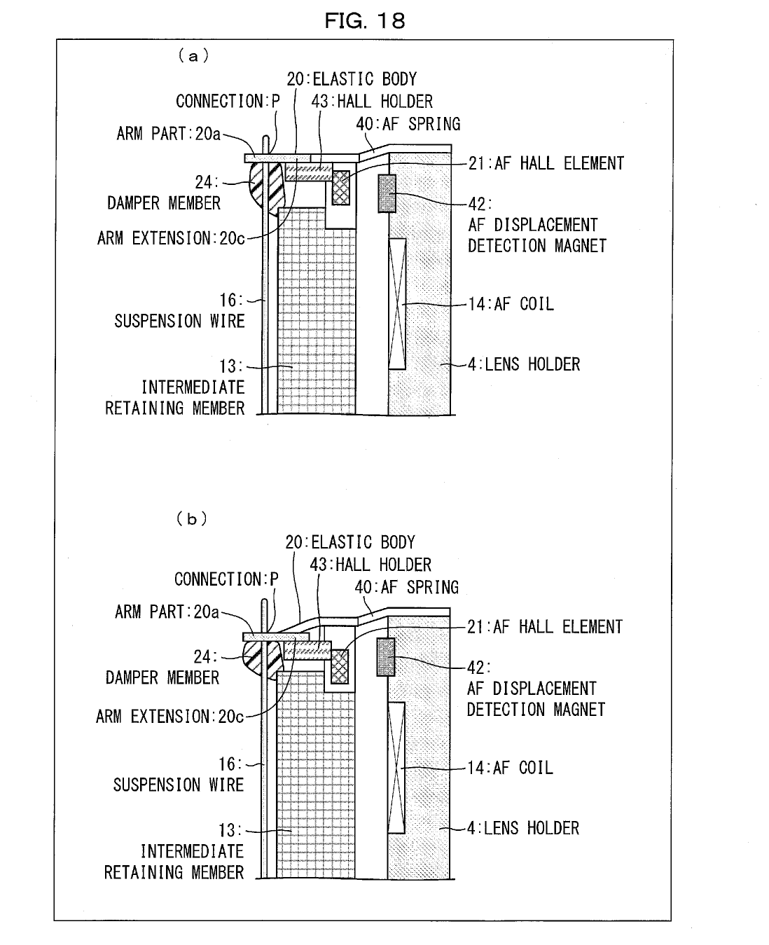

(a) of FIG. 18 is a cross-sectional view illustrating the camera module illustrated in FIG. 17, viewed along arrows F-F, in a state where an intermediate retaining member is not displaced. (b) of FIG. 18 is a cross-sectional view illustrating the camera module in FIG. 17, viewed along the arrows F-F, in a state where the intermediate retaining member is displaced.

### DESCRIPTION OF EMBODIMENTS

The following description will discuss in detail Embodiments of the present invention.

### Embodiment 1

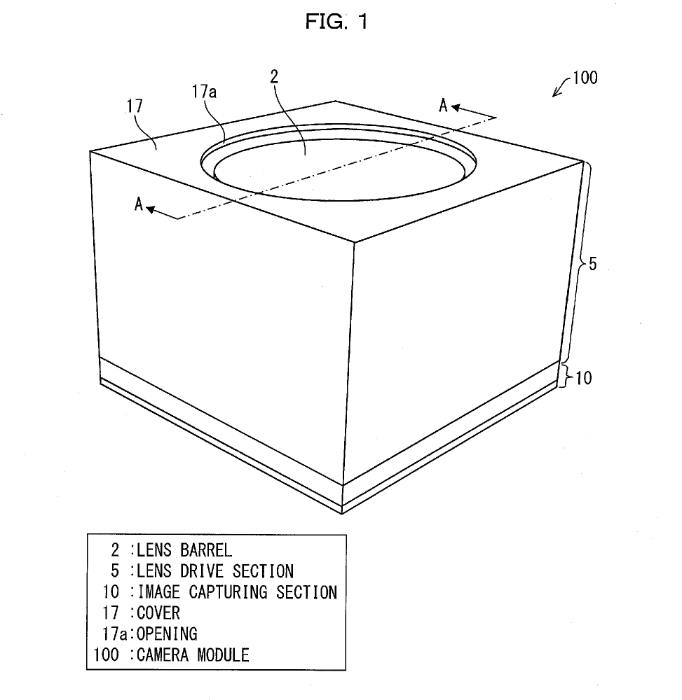

First, a camera module 100 in accordance with Embodiment 1 of the present invention will be described below with reference to FIGS. 1 through 9.

(Configuration of Camera Module 100)

FIG. 1 is a perspective view schematically illustrating a configuration of a camera module 100. The camera module 100 in accordance with Embodiment 1 is a camera module having an autofocus function and an optical image stabilization (OIS: Optical Image Stabilizer) function.

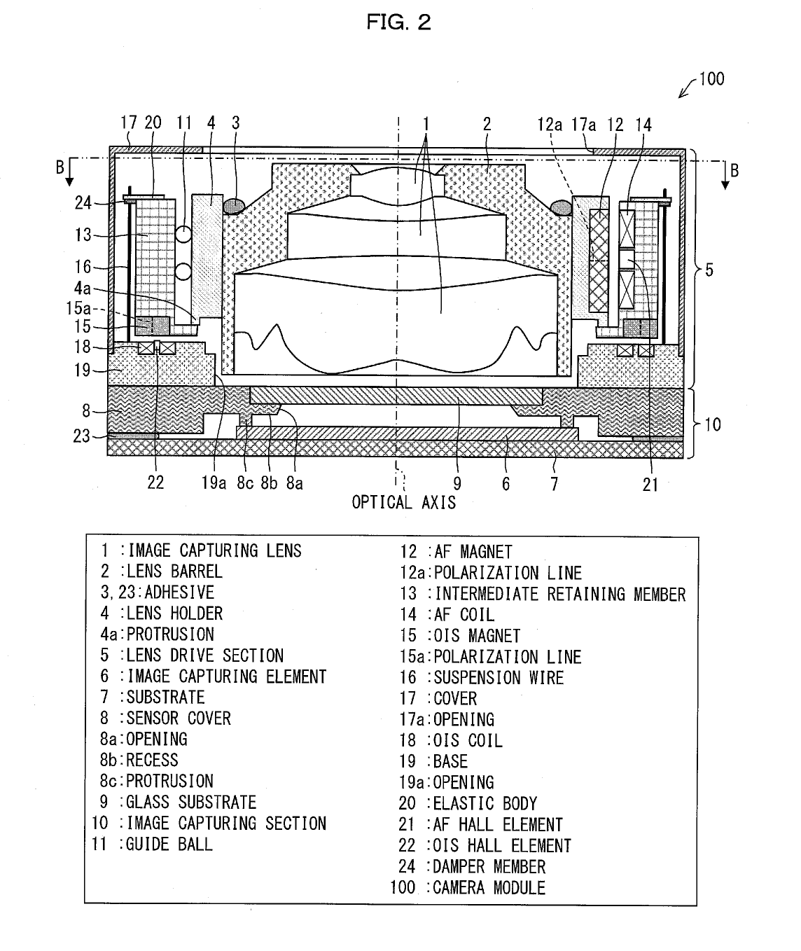

As illustrated in FIG. 1, the camera module 100 includes a lens drive section 5, an image capturing section 10, and a cover 17 which covers the lens drive section 5. The cover 17 has an opening 17a at a position above image capturing lenses 1 (see FIG. 2). The lens drive section 5 and the image capturing section 10 are stacked in a direction of an optical axis of the image capturing lenses 1.

For convenience, the following description assumes that a side where the lens drive section 5 is provided is an upper side while a side where the image capturing section 10 is provided is a lower side. Note however that this assumption by no means defines upper and lower directions in a case where the camera module 100 is used, but for example, the upper and lower sides can be reversed.

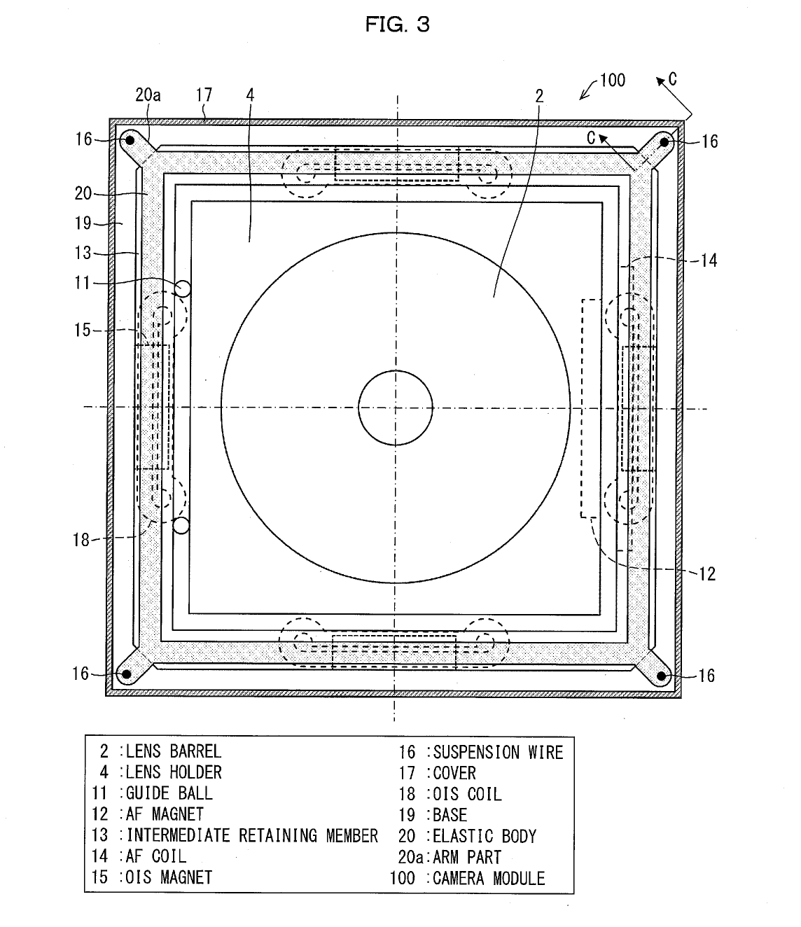

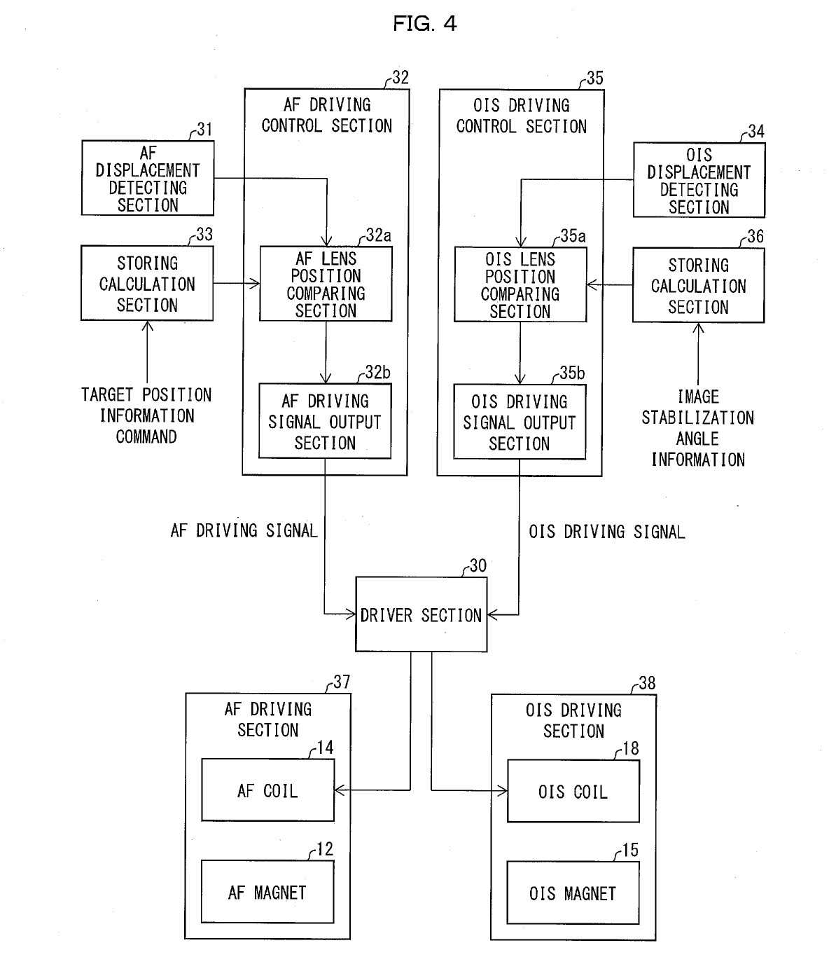

First, with reference to FIGS. 2, 3, and 4, an overall structure of the camera module 100 will be described below. FIG. 2 is a cross-sectional view schematically illustrating the configuration of the camera module 100 illustrated in FIG. 1, viewed along arrows A-A. FIG. 3 is a cross-sectional view schematically illustrating the configuration of the camera module 100 illustrated in FIG. 2, viewed along arrows B-B. In FIG. 2, the position of the optical axis of the image capturing lenses 1 is indicated by a broke line. FIG. 4 is a block diagram illustrating example control blocks of the camera module 100.

(Lens Drive Section 5)

The lens drive section 5 is a section for driving the image capturing lenses 1 in the direction of the optical axis and in directions of two axes which are each perpendicular to the optical axis and which are perpendicular to each other. As illustrated in FIGS. 2 and 3, the lens drive section 5 includes a plurality (three in FIG. 2) of image capturing lenses 1, a lens barrel 2, a lens holder 4, guide balls 11, an intermediate retaining member 13, suspension wires (supports) 16, a base 19, an elastic body 20, an AF Hall element 21 (AF displacement detecting section 31, see FIG. 4), OIS Hall elements 22 (OIS displacement detecting section 34, see FIG. 4), an AF magnet 12 and an AF coil 14 (AF driving section 37, see FIG. 4), and OIS magnets 15 and OIS coils 18 (OIS driving section 38, see FIG. 4). As illustrated in FIG. 4, the lens drive section 5 includes a driver section 30, an AF displacement detecting section 31 (AF Hall element 21), an AF driving control section 32, a storing calculation section 33, an OIS displacement detecting section 34 (OIS Hall elements 22), an OIS driving control section 35, a storing calculation section 36, an AF driving section 37 (AF coil 14 and AF magnet 12), and an OIS driving section 38 (OIS coils 18 and OIS magnets 15).

The image capturing lenses 1 guide external light to an image capturing element 6 of the image capturing section 10. The image capturing element 6 has an axis corresponding to the optical axis of the image capturing lenses 1.

The lens barrel 2 holds therein the plurality of image capturing lenses 1. The lens barrel 2 also has an axis corresponding to the optical axis of the image capturing lenses 1. The lens barrel 2 and the lens holder 4 are fixed with use of an adhesive 3 in such a manner that the lens barrel 2 is located at a predetermined position while the lens holder 4 is being located at a mechanical end on an infinity side.

Further, in Embodiment 1, as illustrated in FIG. 2, part of the lens barrel 2 enters an opening 19a of the base 19 in a state where the lens barrel 2 is embedded in the camera module 100. The following provides reasons why the lens barrel 2 is arranged as described above.

First, the following description will discuss a case where no part of the lens barrel 2 is arranged to enter the opening 19a of the base 19 in the state where the lens barrel 2 is embedded in the camera module 100. In this case, it is necessary to secure, as a distance from a bottom surface of the lens barrel 2 to an upper surface of the image capturing element 6, that is, a flange focal distance, a distance including a space between the image capturing element 6 and a glass substrate 9, a thickness of the glass substrate 9, a thickness of the base 19, and a space between the base 19 and the lens barrel 2. Accordingly, in a case where the flange focal distance is limited, the space between the image capturing element 6 and the glass substrate 9 inevitably becomes narrower and a distance between the image capturing element 6 and the glass substrate 9 becomes shorter. As a result, in a case where a foreign substance falls on the glass substrate 9, unexpected image reflection of the foreign substance onto the image capturing element 6 has a greater degree of influence. Therefore, it is desirable to take a large flange focal distance so as to obtain a higher design freedom degree in arrangement of members.

However, there is a limitation in optical design. On this account, in Embodiment 1, the lens barrel 2 is arranged to enter the opening 9a so as not only to secure the distance between the image capturing element 6 and the glass substrate 9 but also to provide a practical flange focal distance. This makes an apparent thickness of the base 19 in the lens drive section 5 equal to zero.

As described above, the lens barrel 2 including the plurality of built-in image capturing lenses 1 is fixed with use of the adhesive 3 to the lens holder 4. Accordingly, the image capturing lenses 1 and the lens barrel 2 are driven integrally with the lens holder 4.

Further, a position on the lens holder 4 to which position the lens barrel 2 is fixed is determined in advance by height adjustment with use of a jig etc. For example, a space of approximately 10 μm is formed between the lens barrel 2 and a sensor cover 8 of the image capturing section 10. In order that a position of the lens barrel 2 is fixed in a state where the space of approximately 10 μm is formed as described above, the lens barrel 2 can be attached to the lens holder 4 while the position of the lens barrel 2 is kept by use of a jig.

Furthermore, the lens holder 4 has a protrusion 4a at the mechanical end on the infinity side in a displacement range in the direction of the optical axis in which displacement range the lens holder 4 is displaceable (at a reference position on an image-capturing-element-6 side in the displacement range of the lens holder 4). The protrusion 4a contacts the intermediate retaining member 13. In addition, the AF magnet 12 is fixed to one of outer peripheral surfaces of the lens holder 4 which outer peripheral surfaces are parallel to the optical axis of the lens holder 4.

The AF magnet 12 is used as an AF drive magnet (magnetic drive means) for causing an AF movable section (later described) to be magnetically driven. The AF magnet 12 is also used as an autofocus displacement detection magnet which generates a magnetic field for use in detecting displacement of the AF movable section (later described) in the direction of the optical axis.

The lens holder 4 is supported by the guide balls 11 so as to be displaceable in the direction of the optical axis with respect to the intermediate retaining member 13. The guide balls 11 function as guide means for guiding the lens holder 4 so that the lens holder 4 can move in the direction of the optical axis.

The guide balls 11 support the lens holder 4 so that the lens holder 4 is displaceable in the direction of the optical axis with respect to the intermediate retaining member 13. Note that the guide balls 11 are sandwiched between the intermediate retaining member 13 and the lens holder 4. More specifically, the guide balls 11 are provided between (i) one of inner peripheral surfaces of the intermediate retaining member 13 which inner peripheral surfaces are parallel to the optical axis and (ii) one of the four outer peripheral surfaces of the lens holder 4 which outer peripheral surfaces are parallel to the optical axis. In Embodiment 1, as illustrated in FIGS. 2 and 3, two rows of the guide balls 11 are provided between (i) one inner peripheral surface (left side in FIG. 2) of the inner peripheral surfaces of the intermediate retaining member which one inner peripheral surface is opposed to another inner peripheral surface (right side in FIG. 2) to which the AF magnet 12 is fixed and (ii) one outer peripheral surface of the lens holder 4 which one outer peripheral surface is opposed to the one inner peripheral surface of the intermediate retaining member 13. The number of the guide balls 11 in one row is basically 2, but can be three for the purpose of regulating a space between the two guide balls 11 in two row.

Furthermore, the number of rows of the guide balls 11 and the number of the guide balls 11 are set as appropriate so that no gap will be present between the guide balls 11 and the intermediate retaining member 13 or between the guide balls 11 and the lens holder 4. For example, rows of the guide balls 11 can be provided in such a manner that one row is between one outer peripheral surface of the lens holder 4 and one inner peripheral surface of the intermediate retaining member 13 and another row is between another outer peripheral surface of the lens holder 4 and another inner peripheral surface of the intermediate retaining member 13. Alternatively, the guide balls 11 can be provided between (i) the inner peripheral surface of the intermediate retaining member 13 to which inner peripheral surface the AF magnet 12 is fixed and (ii) an outer peripheral surface of the lens holder 4 which outer peripheral surface is opposed to that inner peripheral surface.

In any case, the guide balls 11 are sandwiched between the intermediate retaining member 13 and the lens holder 4. Accordingly, it is desirable to have, for example, a configuration in which the guide balls 11 are prevented from moving by exertion of magnetic attraction force between the intermediate retaining member 13 and the lens holder 4 all the time except during autofocusing. More specifically, though not illustrated, for the exertion of the magnetic attraction force, a magnet for magnetic attraction can be provided to either one of the intermediate retaining member 13 and the lens holder 4 while a magnetic body can be provided to the other one of the intermediate retaining member 13 and the lens holder 4. Alternatively, in a case where the guide balls 11 are provided between (i) the inner peripheral surface of the intermediate retaining member 13 to which inner peripheral surface the AF magnet 12 is fixed and (ii) the outer peripheral surface of the lens holder 4 which outer peripheral surface is opposed to that inner peripheral surface, a magnetic body is provided on an intermediate-retaining-member-13 side so as to be opposed to the AF magnet 12. This allows for exertion of pinching force on the guide balls 11 which are sandwiched between the intermediate retaining member 13 and the lens holder 4.

Note that in place of the guide balls 11, for example, a spring support structure (AF spring) can be used so that the lens holder 14 is supported so as to be displaceable in the direction of the optical axis with respect to the intermediate retaining member 13. In a case where the AF spring is used and this AF spring is integrated with the elastic body 20, a single member can function both as a support for the lens holder 4 and as a shock-absorber for suspension wires 16.

Further, the number, an interval, and the like of the guide balls 11 are items to be set as appropriate. If the interval between the guide balls 11 is set wider, stronger support will be provided for the lens holder 4 which is inclined.

The intermediate retaining member 13 is a hollow quadrangular member whose top and bottom are open. The intermediate retaining member 13 is provided so as to surround the lens holder 4. The AF coil 14 is fixed to the intermediate retaining member 13 at a position facing the AF magnet 12. Furthermore, the AF Hall element 21 and an AF control element (AF driving control section 32 later described) are fixed in an integrated manner to a middle part of a coiled part of the AF coil 14. Furthermore, the OIS magnets 15 are fixed to a bottom surface of the intermediate retaining member 13. Each of the OIS magnets 15 is used not only as an OIS drive magnet (magnetic drive means) for causing an OIS movable section (later described) to be magnetically driven, but also as an image stabilization displacement detection magnet which generates a magnetic field for detection of displacement of the OIS movable section (later described) in the directions of the two axes which are each perpendicular to the direction of the optical axis.

Further, the intermediate retaining member 13 is supported by four suspension wires 16 so as to be displaceable in the directions of the two axes which are each perpendicular to the optical axis, with respect to the base 19 which is not moved (which cannot be displaced).

The OIS movable section (image stabilization movable section) to be driven by the OIS driving section 38 includes an AF movable section (autofocus movable section) (later described), the guide balls 11, the OIS magnets 15, the elastic body 20, and the intermediate retaining member 13 (AF fixed section, autofocus fixed section). Note that the base 19 is connected to the cover 17 and the sensor cover 8, and is not displaced in any direction. Accordingly, the base 19 is not displaced during image stabilization, and functions as an OIS fixed section (image stabilization fixed section).

The elastic body (elastic supporting member) 20 is provided at upper ends of the suspension wires 16. The elastic body 20 is elastically deformable in the direction of the optical axis, and has a lower spring constant as compared to each spring constant of the suspension wires 16 in a longitudinal direction.

The suspension wires (supports) 16 support the intermediate retaining member 13 so that the intermediate retaining member 13 is displaceable in the directions of the two axes which are each perpendicular to the direction of the optical axis, with respect to the base 19. The suspension wires 16 are made of, for example, long and thin metal wires, and extend parallel to the optical axis. Note that the longitudinal direction of the suspension wires 16 can be non-identical to the direction of the optical axis. For example, the four suspension wires 16 can be arranged such that the four suspension wires 16 are slightly inclined so as to have such a truncated chevron shape that a distance between adjacent ones of the four suspension wires 16 gradually increases from the upper side to the lower side or so as to have such an inverted truncated chevron shape that the distance between adjacent ones of the four suspension wires 16 gradually decreases from the upper side to the lower side. It is more desirable to arrange the suspension wires 16 so that the suspension wires 16 have such an inverted truncated chevron shape that the distance between adjacent ones of the suspension wires 16 gradually decreases from the upper side to the lower side. In other words, the suspension wires 16 can extend in a slanted manner with respect to the optical axis.

The suspension wires 16 each have a lower end connected to the base 19. The lower end of each of the suspension wires 16 may be connected with a resin part of the base 19. Meanwhile, in a case where the suspension wires 16 are used as electrifying means, the lower end of each of the suspension wires 16 may be connected with a substrate part of the base 19 on which substrate part electric wiring is provided. Note that another Embodiment will discuss an example in which the lower end of each of the suspension wire 16 is connected to the substrate part.

On the other hand, the suspension wires 16 each have an upper end connected to the intermediate retaining member 13 via the elastic body 20. This configuration allows for absorption of a drop impact. More specifically, the suspension wires 16 each have a very large spring constant related to expansion and contraction in the longitudinal direction of the suspension wires 16. Accordingly, in a case where any of the suspension wires 16 is slightly deformed due to a strong force, the suspension wire 16 may be plastically-deformed and consequently broken. The force caused by a drop impact is very strong. Accordingly, if no measure is taken against a drop impact, the suspension wires 16 have a very high risk of damage (buckling or fracturing) due to a drop impact.

In order to solve the above problem, the suspension wires 16 and the intermediate retaining member 13 are connected to each other via the elastic body 20, so that the elastic body 20 can bear much of deformation caused by applied force. This makes it possible to suppress deformation in the longitudinal direction of the suspension wires 16 and thereby prevent the suspension wires 16 from being damaged due to a drop impact.

Further, the elastic body 20 is made of a conductive metal material. Accordingly, when a terminal of the Hall element with the AF coil 14, a terminal of the control element, and/or the like is connected to the elastic body 20, the suspension wires 16 can be used as part of electrifying means.

The base 19 is a hollow quadrangular member whose top and bottom are open. The base 19 is provided so as to surround the lens holder 4. Further, the base 19 is provided below the intermediate retaining member 13, so as to contact an upper surface of the sensor cover 8. Further, the OIS coils 18 are fixed at respective positions on the base 19 which positions face the respective OIS magnets 15. An OIS Hall element 22 is fixed to a middle part of a coiled part of an OIS coil 18. Note however that a position where the OIS Hall element 22 is fixed is not necessarily at the middle part of the coiled part of the OIS coil 18. For example, the OIS coil 18 to be provided at one position can be divided into two portions and the OIS Hall element 22 may be provided at a middle part between the two portions. In a case where the OIS Hall element 22 is provided at the middle part between the two portions into which the OIS coil 18 is divided, the OIS Hall element 22 is less influenced by magnetic-field noise which occurs when a current is applied to the OIS coil 18.

Further, though not illustrated, the base 19 is provided with a first image stabilization detecting section for detecting first image stabilization angle information and a second image stabilization detecting section for detecting second image stabilization angle information. The first image stabilization angle information indicates a camera-shake angle (posture change, i.e., a shake angle of the image capturing lenses 1) of the camera module 100 in a first direction perpendicular to the optical axis of the image capturing lenses 1. The second image stabilization angle information indicates a camera-shake angle of the camera module 100 in a second direction perpendicular to the optical axis of the image capturing lenses 1 (direction perpendicular to the optical axis and the first direction). The image stabilization detecting sections each can employ, for example, an angular velocity detecting element such as a gyro sensor, and can detect, for example, angular information by integration of an angular velocity which has been detected by the gyro sensor. Note that positions where the first and second image stabilization detecting sections are provided are not limited to the base 19. These image stabilization detecting sections can be provided, for example, in a housing of a mobile terminal including the camera module 100. The image stabilization detecting sections each can be provided at any position as long as the position is not part of the OIS movable section of the camera module 100.

As illustrated in FIG. 4, the OIS driving section 38 (image stabilization driving section) includes the OIS magnets 15 and the OIS coils 18.

The OIS driving section 38 drives the OIS movable section in the directions of the two axes which are each perpendicular to the direction of the optical axis, with respect to the base 19. The OIS driving section 38 carries out such driving by a magnetic force which occurs between each of the OIS magnets 15 and a corresponding one of the OIS coils 18. The OIS driving section 38 is driven under control of the OIS driving control section 35.

As illustrated in FIGS. 2 and 3, the OIS coils 18 are fixed to respective sides of an upper surface of the base 19. Further, the OIS coils 18 are provided at the respective positions which face the respective OIS magnets 15. Furthermore, each axis of the OIS coils 18 is parallel to the optical axis. When a current is caused to flow in each of the OIS coils 18, a magnetic force that occurs between the each of the OIS coils 18 and a corresponding one of the OIS magnets 15 is exerted on the intermediate retaining member 13. As a result, the lens holder 4 is driven (displaced) integrally together with the image capturing lenses 1 and the lens barrel 2 in directions each perpendicular to the optical axis.

Note that an OIS coil 18 provided along one of the sides of the upper surface of the base 19 makes a set with another OIS coil 18 provided along another one of the sides of the upper surface which another one is opposed to the one via the lens holder 4. This set of the OIS coils 18 applies a force in the first direction perpendicular to the optical axis (direction perpendicular to the optical axis and the axes of the OIS coils 18). Further, OIS coils 18 which are provided along the other two of the sides of the upper surface of the base 19 make another set and apply a force along the second direction perpendicular to the optical axis (direction perpendicular to the optical axis and the first direction). Note that the above sets of the OIS coils 18 are connected to each other in series.

As illustrated in FIG. 4, the AF driving section 37 (autofocus driving section) includes the AF magnet 12 and the AF coil 14.

The AF driving section 37 drives the AF movable section (later described) in the direction of the optical axis, with respect to the intermediate retaining member 13. The AF driving section 37 carries out such driving by a magnetic force which occurs between the AF magnet 12 and the AF coil 14. The AF driving section 37 is driven under control of the AF driving control section 32.

As illustrated in FIGS. 2 and 3, the AF coil 14 is provided and fixed onto an inner side surface of the intermediate retaining member 13. Moreover, the AF coil 14 is provided at a position which faces the AF magnet 12. Further, an axis of the AF coil 14 is perpendicular to the optical axis. When a current is caused to flow in the AF coil 14, a magnetic force that occurs between the AF coil 14 and the AF magnet 12 is exerted on the lens holder 4. As a result, the lens holder 4 is driven (displaced), in the direction of the optical axis, integrally together with the image capturing lenses 1 and the lens barrel 2.

The AF movable section, which is driven by AF driving section 37, includes the image capturing lenses 1, the lens barrel 2, the adhesive 3, the lens holder 4, and the AF magnet 12. The intermediate retaining member 13 is connected to the base 19 by the suspension wires 16, and displaced in the first and second directions each of which is perpendicular to the optical axis. The intermediate retaining member 13 however is not basically displaced in the direction of the optical axis. Accordingly, the intermediate retaining member 13 is displaced during image stabilization but not during autofocusing. Accordingly, the intermediate retaining member 13 functions as an AF fixed section.

The AF Hall element 21 (AF displacement detecting section 31, autofocus displacement detecting section) includes therein a magnetic flux density detecting element (not illustrated). The AF Hall element 21 detects a change in magnetic flux density of the AF magnet 12, which is moved (AF displacement) by AF driving, by use of the magnetic flux density detecting element. Thereby, the AF Hall element 21 detects displacement of the AF movable section in the direction of the optical axis. Further, as illustrated in FIG. 2, the AF Hall element 21 is provided, integrally with the AF control element (AF driving control section 32), to the middle part of the coiled part of the AF coil 14 which is fixed to the intermediate retaining member 13. In a case where the AF Hall element 21 detects displacement of the AF movable section in the direction of the optical axis, with respect to the AF fixed section, the AF Hall element 21 supplies an AF displacement detection signal to the AF driving control section 32 as illustrated in FIG. 4.

Each of the OIS Hall elements 22 (OIS displacement detecting section 34, image stabilization displacement detecting section) includes therein a magnetic flux density detecting element (not illustrated). The each of the OIS Hall elements 22 detects a change in magnetic flux density of the OIS magnets 15, which are moved (OIS displacement) by OIS driving, by use of the magnetic flux density detecting element. Thereby, the OIS Hall elements 22 detect displacement of the OIS movable section in the respective directions of the two axes which are each perpendicular to the direction of the optical axis. More specifically, two OIS Hall elements 22 are provided, and the two OIS Hall elements 22 each independently perform detection. One of the two OIS Hall elements 22 detects displacement in the first direction perpendicular to the optical axis, while the other one of the two OIS Hall elements 22 detects displacement in the second direction perpendicular to the optical axis. Further, as illustrated in FIG. 2, the OIS Hall element 22 is provided to the middle part of the coiled part of the OIS coil 18 which is fixed to the base 19.

Note that though only one OIS Hall element 22 is illustrated in FIG. 2, another OIS Hall element 22 is provided at another position which is 90 degrees turned from a position where the one OIS Hall element 22 illustrated in FIG. 2 is provided. This is intended to detect displacement in two directions. In a case where the OIS Hall elements 22 detect displacement of the OIS movable section in the respective two directions each of which is perpendicular to the direction of the optical axis, with respect to the OIS fixed section, the OIS Hall elements 22 supply respective OIS displacement detection signals to the OIS driving control section 35, as illustrated in FIG. 4.

Note that in place of the AF hall element 21 and the OIS Hall elements 22, a magnetoresistive element such as an MR (magneto-resistive) element or a GMR (Giant Magneto-Resistance) element can be used. Types of the AF displacement detecting section 31 and the OIS displacement detecting section 34 can be freely selected in consideration of required detection sensitivity and cost.

The storing calculation section 33 stores therein respective voltages associated with digital code numbers indicative of position information corresponding to AF displacement detection signals which vary along a full stroke from an infinity side to a macro side of the image capturing lenses 1. More specifically, for example, voltages in a range of 0 (zero) V through P₁ V (P₁ V is any voltage value, e.g., P₁ V=3 V) are divided into 1024 levels and the 1024 levels of the voltages are stored in association with respective code numbers (addresses).

The storing calculation section 36 stores therein conversion factors for optimization of an OIS lens displacement (displacement of the image capturing lenses 1) for image stabilization. The conversion factors are stored in association with the first image stabilization angle information and the second image stabilization angle information. Then, the storing calculation section 36 outputs a voltage corresponding to target lens position information (target position of the OIS movable section).

The AF driving control section 32 (autofocus driving control section) includes an AF lens position comparing section 32a and an AF driving signal output section 32b. The AF driving control section 32 controls the AF driving section 37 by feedback control in which an AF displacement detection signal obtained from the AF displacement detecting section 31 is repeatedly compared with a target value. More specifically, the AF driving control section 32 supplies, to the driver section 30, an AF driving signal for driving the AF movable section to a target position, in accordance with an AF displacement detection signal from the AF displacement detecting section 31, a storing calculation section 33, and a target position information command. The AF driving section 37 displaces the AF movable section in accordance with an output from the driver section 30 which output is based on the AF driving signal. In so doing, the AF movable section being supported by the guide balls 11 is displaced by the AF driving section 37 in the direction of the optical axis, with respect to the AF fixed section. The feedback control of autofocusing will be later described in detail.

The OIS driving control section 35 (image stabilization driving control section) includes an OIS lens position comparing section 35a and an OIS driving signal output section 35b. The OIS driving control section 35 controls the OIS driving section 38 by feedback control in which an OIS displacement detection signal obtained from the OIS displacement detecting section 34 is repeatedly compared with a target value. More specifically, the OIS driving control section 35 supplies, to the driver section 30, an OIS driving signal for driving the OIS movable section to a target position, in accordance with the OIS displacement detection signal from the OIS displacement detecting section 34, the storing calculation section 36, the first image stabilization angle information from the first image stabilization detecting section, and the second image stabilization angle information from the second image stabilization detecting section. The OIS driving section 38 displaces the OIS movable section in accordance with an output from the driver section 30 which output is based on the OIS driving signal. In so doing, the OIS movable section being supported by the suspension wires 16 is displaced in the directions of the two axes which are each perpendicular to the direction of the optical axis, with respect to the OIS fixed section. The feedback control of OIS will be later described in detail.

As illustrated in FIG. 4, the driver section 30 drives the AF driving section 37 in accordance with the AF driving signal from the AF driving control section 32. Meanwhile, the driver section 30 drives the OIS driving section 38 in accordance with the OIS driving signal from the OIS driving control section 35.

(Image Capturing Section 10)

The image capturing section 10 includes the image capturing element 6, a substrate 7, the sensor cover 8, and the glass substrate 9.

The image capturing element 6 is mounted on the substrate 7. Receiving light having reached the image capturing element 6 via the image capturing lenses 1, the image capturing element 6 carries out photoelectric conversion of the light and thereby obtains an object image formed on the image capturing element 6. An upper surface of the substrate 7 and a lower surface of the sensor cover 8 are fixed to each other with use of an adhesive 23.

The sensor cover 8 is a rectangular member provided below the base 19 and placed so as to cover the whole of the image capturing element 6. Moreover, the sensor cover 8 has a recess 8b provided on a bottom side of the sensor cover 8. The recess 8b has an opening 8a which vertically penetrates through the sensor cover 8, in a center area of the sensor cover 8. The glass substrate 9 is provided on the recess 8b so as to close the opening 8a. The glass substrate 9 is not limited in material but can be made of, for example, a material having an infrared ray blocking function.

Further, the sensor cover 8 has a protrusion 8c protruding downward at a part in a peripheral region of the recess 8b on the bottom side of the sensor cover 8. The protrusion 8c has a bottom surface which serves as a bottom reference surface of the sensor cover 8. The camera module 100 is assembled in such a manner that this bottom reference surface contacts the upper surface of the image capturing element 6. This allows for highly-accurate positioning of the image capturing lenses 1 with respect to the image capturing element 6 in the direction of the optical axis. More specifically, when the image capturing element 6 is brought into contact with the protrusion 8c of the sensor cover 8, a gap occurs between the substrate 7 and the sensor cover 8 due to tolerance. The sensor cover 8 and the substrate 7 are adhered to each other by filling this gap with the adhesive 23. This consequently makes it possible to reduce a tilt of the image capturing lenses 1 with respect to the image capturing element 6 after assembly. The lens drive section 5 is stacked on the sensor cover 8.

(OIS Function and AF Function)

The above configuration allows the lens drive section 5 to drive with a magnetic force the image capturing lenses 1 in directions of three axes in total, one of which is the optical axis and the other two of which are two axes that are each perpendicular to the optical axis and also perpendicular to each other. Both an autofocus (AF) function and an optical image stabilization (OIS) function are realized by driving the image capturing lenses 1 in the directions of the three axes, with respect to the image capturing element 6 of the image capturing section 10.

The AF function is realized by moving the AF movable section up and down between an infinity end and a macro end of the image capturing lenses 1, with respect to the image capturing element 6 (i.e., displacement of the plurality of image capturing lenses 1 in the direction of the optical axis, with respect to the image capturing element 6). In other words, the AF function is realized by displacement of the AF movable section including the image capturing lenses 1, in the direction of the optical axis of the image capturing lenses 1. Note that the infinity end of the image capturing lenses 1 means a position at which an object at infinity is focused, whereas the macro end of the image capturing lenses 1 means a position at which an object at a desired macro distance (e.g., 10 cm) is focused.

The OIS function is realized by moving, with respect to the image capturing element 6, the OIS movable section in directions each of which is perpendicular to the optical axis, in accordance with an amount and a direction of camera shake (i.e., relatively displacing, with respect to the image capturing element 6, the plurality of image capturing lenses 1 in the directions each of which is perpendicular to the optical axis). In other words, the OIS function is realized by displacement of the OIS movable section, including the AF movable section, in the two directions, which are each perpendicular to the optical axis and which are perpendicular to each other.

(Feedback Control of AF Driving Section 37)

Next, the feedback control of the AF driving section 37 will be described below with reference to FIG. 4.

The AF driving control section 32 includes the AF lens position comparing section 32a and the AF driving signal output section 32b.

The AF lens position comparing section 32a compares (i) a voltage corresponding to an actual position of the AF movable section which position is based on an AF displacement detection signal supplied from the AF displacement detecting section 31 with (ii) a voltage corresponding to a target position of the AF movable section, which voltage is associated with a code number from a target position command and is stored in the storing calculation section 33. In a case where there is a difference between (i) the voltage corresponding to the actual position of the AF movable section and (ii) the voltage corresponding to the target position of the AF movable section, the AF lens position comparing section 32a supplies, to the AF driving signal output section 32b, a signal for driving the AF movable section so as to reduce the difference.

Upon receipt of the above signal, the AF driving signal output section 32b supplies, to the driver section 30, an AF driving signal which is based on the signal.

Upon receipt of the AF driving signal, the driver section 30 causes an electric current which is based on the AF driving signal to flow in the AF coil 14. This generates a magnetic force between the AF coil 14 and the AF magnet 12, and causes the lens holder 4 (AF movable section) to be driven (displaced) by the magnetic force in the direction of the optical axis, with respect to the intermediate retaining member 13 (AF fixed section, autofocus fixed section).

When the lens holder 4 is displaced in the direction of the optical axis with respect to the intermediate retaining member 13, the AF displacement detection signal outputted from the AF displacement detecting section 31 accordingly changes. Therefore, the AF lens position comparing section 32a newly compares (i) a voltage corresponding to a new position of the AF movable section which position is based on a newly detected AF displacement detection signal with (ii) the voltage corresponding to the target position of the AF movable section. Such comparison will be repeated until a voltage corresponding to an actual position of the AF movable section becomes identical to the voltage corresponding to the target position of the AF movable section.

Note that a subject for comparison by the AF lens position comparing section 32a is not limited to voltages. The AF lens position comparing section 32a can, for example, directly compare codes (addresses) associated with voltages.

In a case where a pulse current is applied so that the AF movable section will be driven to a target position by non-feedback control, an overshoot occurs in accordance with the vibration theory. This is because no misalignment can be detected even in a case where the AF movable section moves beyond the target position. As a result, transient vibration occurs. This results in a problem that a lot of time is needed for returning the AF movable section back to the target position. By carrying out the feedback control of the AF movable section, it is possible to detect a misalignment of the AF movable section with respect to the target position and carry out control for eliminating the misalignment. This eliminates the need for locating a focus position by minutely moving the AF movable section. Consequently, the transient vibration hardly occurs, so that high-speed autofocusing can be achieved.

Further, as described above, the AF Hall element 21 and the AF control element are provided integrally with each other. The AF control element is provided, for example, in the form of a single package in which two chips including the AF Hall element 21 and a silicon LSI are combined. If the AF Hall element 21 and the AF control element were not integrated with each other and the AF control element were provided to the AF fixed section, necessary wirings would be six wirings two of which are intended to electrify the AF coil 14 and the other four of which are intended to electrify the AF Hall element 21. As a result, electrification would be impossible with the four suspension wires 16. On the other hand, in a configuration where the AF Hall element 21 and the AF control element are integrated with each other and the AF coil 14, the AF Hall element 21, and the AF control element are connected to each other within the lens drive section 5, only four terminals including a supply terminal, a ground terminal, a clock terminal, and a data signal terminal are required for connection with the AF fixed section. Accordingly, electrification is possible merely with the four suspension wires 16 in such a configuration. However, for example, if apart from the four suspension wires 16, not less than six suspension wires 16, specifically, for example, eight suspension wires 16 in view of symmetry are used to support the intermediate retaining member 13, the AF coil 14 and the AF Hall element 21 can be electrified with use of these suspension wires 16. Accordingly, it is not essential to integrate the AF Hall element 21 and the AF control element. Note that in a case where the not less than six suspension wires 16 are used for electrification of the AF coil 14 and the AF Hall element 21, each of the not less than six suspension wires 16 needs to be electrically independent. Accordingly, in such a case, elastic bodies 20, to which the not less than six suspension wires 16 are connected, need to be electrically independent from each other.

Further, in a configuration where the AF Hall element 21 is provided on the intermediate retaining member 13 which is not displaced during autofocusing, only wiring between the OIS movable section and the OIS fixed section is required as wiring between a movable section and a fixed section, which wiring between the movable section and the fixed section serves as means for electrifying the AF Hall element 21. This makes it possible to electrify the AF displacement detecting section 31 by simple wiring. This consequently allows for feedback control of autofocusing and image stabilization by use of simple electrifying means.

(Feedback Control of OIS Driving Section 38)

Next, the feedback control of the OIS driving section 38 will be described below with reference to FIG. 4.

The OIS driving control section 35 includes the OIS lens position comparing section 35a and the OIS driving signal output section 35b. The OIS lens position comparing section 35a compares (i) a voltage corresponding to an actual position of the OIS movable section which position is based on an OIS displacement detection signal supplied from the OIS displacement detecting section 34 with (ii) respective voltages corresponding to target positions of the OIS movable section, which voltages are outputted from the storing calculation section 36 in accordance with the first image stabilization angle information from the first image stabilization detecting section and the second image stabilization angle information from the second image stabilization detecting section.

More specifically, the OIS lens position comparing section 35a compares, for image stabilization in the first direction perpendicular to the direction of the optical axis, (i) a voltage corresponding to an actual position of the OIS movable section in the first direction with (ii) a voltage corresponding to a target position of the OIS movable section in the first direction, which voltage is outputted from the storing calculation section 36 in accordance with the first image stabilization angle information. Moreover, the OIS lens position comparing section 35a compares, for image stabilization in the second direction which is perpendicular to the direction of the optical axis and also perpendicular to the first direction, (i) a voltage corresponding to an actual position of the OIS movable section in the second direction with (ii) a voltage corresponding to a target position of the OIS movable section in the second direction, which voltage is outputted from the storing calculation section 36 in accordance with the second image stabilization angle information. In a case where there is a difference between the voltages in the first direction or the second direction, which voltages are (i) the voltage corresponding to the actual position of the OIS movable section and (ii) the voltage corresponding to the target position of the OIS movable section, the OIS lens position comparing section 35a supplies, to the OIS driving signal output section 35b, a signal for driving the OIS movable section so as to reduce the difference.

Upon receipt of the above signal, the OIS driving signal output section 35b supplies, to the driver section 30, an OIS driving signal which is based on the signal.

Upon receipt of the OIS driving signal, the driver section 30 causes an electric current which is based on the OIS driving signal to flow in each of the OIS coils 18. More specifically, when the driver section 30 is to drive the OIS driving section 38 in accordance with the first image stabilization angle information, the driver section 30 causes an electric current to flow in each of the OIS coils 18 with which the OIS movable section is driven in the first direction. Meanwhile, when the driver section 30 is to drive the OIS driving section 38 in accordance with the second image stabilization angle information, the driver section 30 causes an electric current to flow in each of the OIS coils 18 with which the OIS movable section is driven in the second direction. This generates magnetic forces between the OIS coils 18 and the respective OIS magnets 15 and causes, by the magnetic force, the intermediate retaining member 13 (OIS movable section) to be driven (displaced) in the two directions each of which is perpendicular to the direction of the optical axis, with respect to the base 19 (OIS fixed section).

When the intermediate retaining member 13 is displaced in the directions of the two axes perpendicular to the direction of the optical axis, with respect to the base 19, the OIS displacement detection signal outputted from the OIS displacement detecting section 34 accordingly changes. Therefore, the OIS lens position comparing section 35a newly compares (i) a voltage corresponding to a new position of the OIS movable section which position is based on a newly detected OIS displacement detection signal with (ii) the voltage corresponding to the target position of the OIS movable section. Such comparison will be repeated until a voltage corresponding to an actual position of the OIS movable section becomes identical to the voltage corresponding to the target position of the OIS movable section.

As in Embodiment 1, by carrying out the feedback control of the OIS movable section, it is possible to detect a misalignment of the OIS movable section with respect to the target position and carry out control for eliminating the misalignment. This makes it possible to improve an image stabilization function and reduce a residual camera shake in a case where a camera shake occurs.

Further, the OIS Hall elements 22 are provided to the OIS fixed section. Accordingly, an OIS control element (not illustrated) (OIS driving control section 35) does not always need to be integrated with the OIS Hall elements 22. In a case where the OIS control element is not integrated, wiring for electrification increases in number as compared with a case where the OIS control element is integrated. However, even in a case where the wiring is large in number, electrification is still easy in a case where the OIS Hall elements 22 and the OIS control element are provided to the fixed section and connected to each other.

(Arrangement of Image Capturing Lenses Etc.)

Next, a location at which the lens barrel 2 is attached to the lens holder 4 will be described below. It is desirable that the image capturing lenses 1 are provided at such a distance away from the upper surface of the image capturing element 6 that a focal point of the lenses is located at the mechanical end on the infinity side. However, there is a concern that an error might remain at positions where component members including the image capturing lenses 1 are attached in each camera module 100 in a case where the camera module 100 is manufactured only by putting component members in contact with each other without focus adjustment. This is because there exist (i) the tolerance in the location at which the image capturing lenses 1 are attached to the lens barrel 2, (ii) the tolerance in the thickness of the sensor cover 8, and the like.

Therefore, in order for the lens drive section 5 to have a focal point within a stroke of the lens drive section 5, preferably, the lens barrel 2 is attached to the lens holder 4 so that the image capturing lenses 1 will be provided so as to be slightly shifted, from a center of designed location values of the focal point, closer to the image capturing element 6 even if the error is present in the camera module 100. Such a slight shift toward the image capturing element 6 is called “over infinity.” In a case where the over infinity is set to be larger, the stroke of the lens drive section 5 becomes larger accordingly. Therefore, the over infinity needs to be kept to a requisite minimum.

According to cumulative total of the various tolerances above, for example, approximately 25 μm is appropriate as the over infinity. Note, however, that since this over infinity is susceptible to the tolerances for manufacturing and assembling of the members, it is desirable that the over infinity is set to a realistic minimum one.

In Embodiment 1, (i) the sensor cover 8 having a sufficiently improved thickness accuracy is employed, (ii) the bottom surface of the protrusion 8c, which serves as the bottom reference surface of the sensor cover 8, is brought into contact with the image capturing element 6, and (iii) the lens barrel 2 is highly precisely located with respect to the upper surface of the sensor cover 8 (i.e. with respect to a bottom surface of the lens drive section 5). Therefore, it can be said that, in Embodiment 1, such a small over infinity as approximately 25 μm is sufficiently large.

In Embodiment 1, the lens barrel 2 is attached to the lens holder 4 so as to be shifted closer, by merely 25 μm, to the image capturing element 6 from a location where an object at infinity is to be focused. Further, there exists a space between the sensor cover 8 and the lens barrel 2 in a state where the lens barrel 2 is attached to the lens holder 4 as described above.

(Elastic Body 20 and Damper Member 24)

As illustrated in FIGS. 2 and 3, a characteristic configuration of the camera module 100 in Embodiment 1 resides in that the elastic body 20 fixed to the intermediate retaining member 13 has parts protruding (extending) from the periphery of the intermediate supporting member 13, which parts form arm parts (extending parts) 20a each having flexibility. The upper ends of respective suspension wires 16 are fixed to substantially end parts of the respective arm parts 20a, and damper members 24 are provided on parts of the respective arm parts 20a (see FIG. 6).

Each of the arm parts 20a functions as an elastic body for suppressing stress applied to a corresponding one of the suspension wires 16. The arm parts 20a are preferably arranged to suppress buckling and permanent strain of the respective suspension wires 16. Examples of a material for the arm parts 20a encompass, but not limited to, metal and plastic. Each of the arm parts 20a can be more preferably made from a material which can sufficiently reduce the spring constant of a corresponding one of the suspension wires 16 and can be kept free of plastic deformation even when subjected to deformation of approximately 150 μm. In a case where the arm parts 20a are soldered to the respective suspension wires 16, it is preferable that the arm parts 20a be each made of metal.

A function of each of the arm parts 20a will be described below in more detail.

Though the intermediate retaining member 13 may be displaced in the direction of the optical axis due to deflection of the suspension wires 16, a displacement of the intermediate retaining member 13 during normal use is negligible. However, in a case where the camera module 100 receives an excessive impact due to dropping on the floor etc., a inertial force is applied, in the direction of the optical axis, to the OIS moving section including the intermediate retaining member 13. In a case where the inertial force is applied to the OIS movable section, the base 19, provided below the intermediate retaining member 13, functions as a stopper (locking member) that defines a limit of a range on the lower side (in FIG. 2) in which range the intermediate retaining member 13 (OIS moving section) is movable in the direction of the optical axis. It is therefore possible to restrict, by the base 19, the displacement of the intermediate retaining member 13 on a lower side in the direction of the optical axis. Further, though not illustrated, the lens drive section 5 has a stopper that defines a limit of a range on the upper side (in FIG. 2) in which range the intermediate retaining member 13 (OIS moving section) is movable in the direction of the optical axis. The stopper can be made of, for example, a protrusion extending upward in the direction of the optical axis from a part of an upper surface of the intermediate retaining member 13 and set a distance between the cover 17 and the protrusion to approximately 150 μm.

However, in order to prevent the OIS movable section from coming into contact with the OIS fixed section, it is crucial to secure a space of approximately 100 μm to 150 μm between the OIS movable section and the OIS fixed section, by taking into consideration the assembling errors etc. Hence, there is a possibility that such a space between the OIS movable section and the OIS fixed section may vary by approximately 150 μm. If an attempt is made to compensate for a deformation amount of the space merely by use of the expansion and contraction of the suspension wires 16, then there is a possibility that each of the suspension wires 16 will receive stress that is beyond its buckling stress or yield stress.

In this regard, according to Embodiment 1, the arm parts 20a are configured to bear part of a deformation amount of the suspension wires 16. This makes it possible to suppress the deformation amount, in the longitudinal direction, of the suspension wires 16. It is therefore possible to suppress, by the arm parts 20a, the stress applied to the suspension wires 16 and thereby sufficiently restrain the buckling and permanent strain of the suspension wires 16.

In order to suitably restrain the stress to be applied to the suspension wires 16, deformation amounts of the arm parts 20a need to be increased. Specifically, it is preferable to configure the arm parts 20a to have a spring constant less than that of the suspension wires 16 in the longitudinal direction. However, in a case where the spring constant of the arm parts 20a is arranged to be smaller than the spring constant of the suspension wires 16 in the longitudinal direction, a resonant frequency of the arm parts 20a is reduced. As such, (i) a resonance is generated in a servo frequency band and (ii) a servo system is then adversely affected.

In this regard, according to Embodiment 1, the arm parts 20a are provided with the respective damper members 24. This allows the vibration of the arm parts 20a to be damped. It is therefore possible to reduce the risk of oscillation of the servo system.

(Spring Constant)

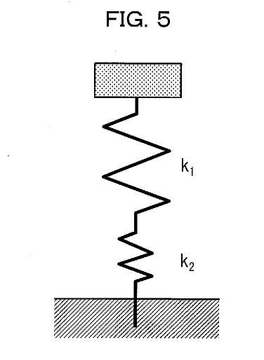

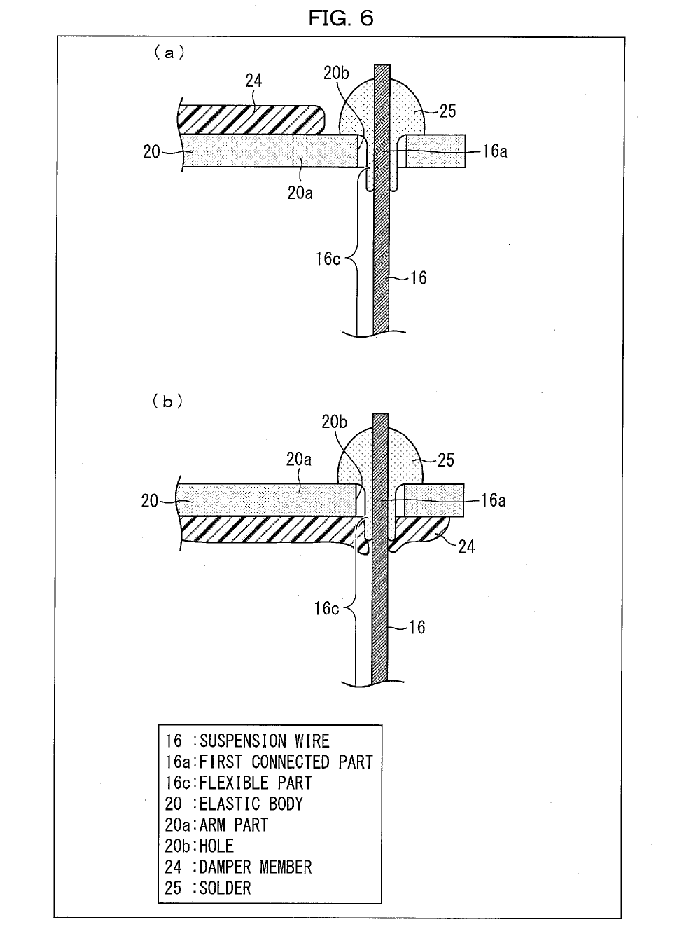

A solution to the dropping of the camera module 100 will be described below in more detail. A relationship between the spring constant of the suspension wires 16 and the spring constant of the arm parts 20a of the elastic body 20 is illustrated in FIG. 5. FIG. 5 is a view schematically illustrating a state where the elastic body 20 and a suspension wire 16 of the camera module 100 are connected to each other. As illustrated in FIG. 5, an arm part 20a and the suspension wire 16 are cascade-connected springs. The arm part 20a has a spring constant k₁. The suspension wire 16 has a spring constant k₂ in the longitudinal direction. For simplification of description, the following description will merely discuss one of the suspension wires 16.

The spring constants k₁ and k₂ are set so that k₁<<k₂. The springs have deformation amounts which are inversely proportional to their respective spring constants, and can be obtained by the following respective expressions (1) and (2):

A deformation amount δ₁ of the elastic body 20 (arm part 20a)=δk₂/(k₁+k₂) (1)

A deformation amount δ₂ of the suspension wire 16=δk₁/(k₁+k₂) (2)

where a total amount of deformation caused by a drop impact is δ (e.g., the space of approximately 150 μm between the intermediate retaining member 13 and the base 19).

The force F required to deform the suspension wire 16 by just δ₂ can be obtained by the following expression (3):

F=δk₁k₂/(k₁+k₂) (3)

Therefore, the stress σ which varies depending on a deformation amount of the suspension wire 16 in the longitudinal direction can be obtained by the following equality (4):

σ=(δ/A)k₁k₂/(k₁+k₂) (4)

where A denotes an area of a cross section of the suspension wire 16.

It is essential that σ do not exceed σₑ, which is the buckling stress of the suspension wire 16. This is because a buckling stress is normally less than a yield stress. Note that k₁ is to be calculated on the assumption that a damper member 24 has been applied to the elastic body 20 (arm part 20a).

That is, the spring constant k₁ of the arm part 20a of the elastic body 20 and the longitudinal-direction spring constant k₂ of the suspension wire 16 are preferably set to meet the following expression (5):

σₑ>(δ/A)k₁k₂/(k₁+k₂) (5)

Normally, the Euler's buckling stress is used as an indication of a buckling stress. The Euler's buckling stress can be represented by the following expression (6):

σₑ=Cπ²E/λ² (6)

where C is a constant; E is the Young's modulus; and λ is a slenderness ratio. The value of C is 4 in a case where a both-end-fixed beam is used.

Note that the Euler's buckling stress was calculated based on one of the design examples, and was approximately 1×10⁸ N/m². Note, however, that the Euler's buckling stress is the one obtained in a case where an ideal vertical load is applied. Also note that the load can be applied in an oblique direction. Thus, the buckling stress is preferably set with some margin. Therefore, it is desirable that k₁ and k₂ are set so that σ does not exceed the buckling stress thus calculated.

(Various Example Configurations of Damper Member 24)

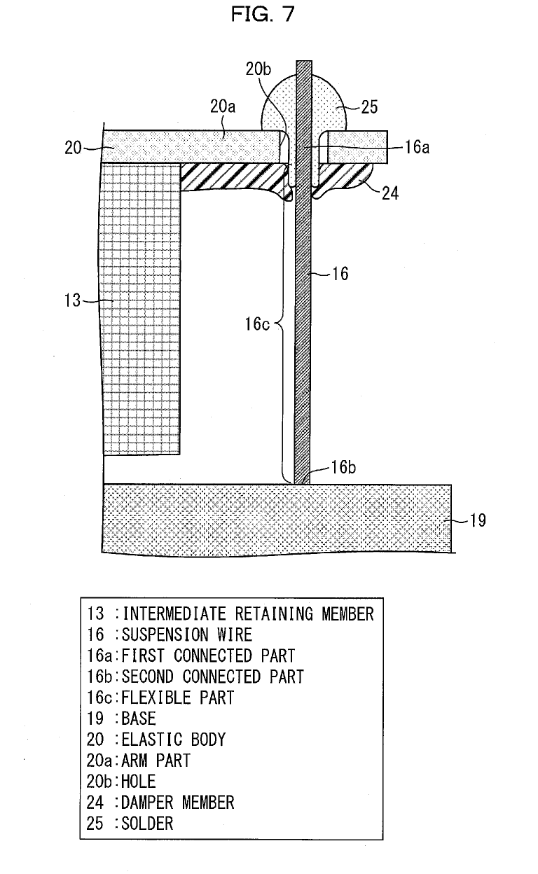

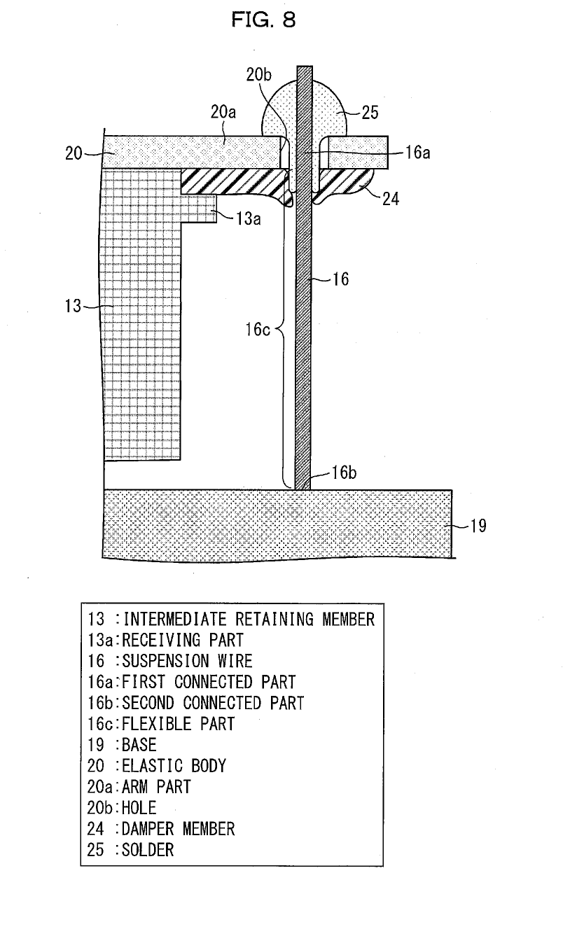

Various example configurations of the damper member 24 will be described below with reference to (a) and (b) of FIG. 6 through FIG. 8. (a) of FIG. 6 is a view schematically illustrating an example configuration of the elastic body 20 and the damper member 24 of the camera module 100. (b) of FIG. 6 is a view schematically illustrating another example configuration of the elastic body 20 and the damper member 24 of the camera module 100. FIGS. 7 and 8 are views each schematically illustrating further another example configuration of the elastic body 20 and the damper member 24 of the camera module 100.

It is possible to attach, to the arm part 20a, a sheet-like rubber material as the damper member 24. Note, however, that ultraviolet-curing gel (i) is more workable and (ii) does not have a large spring constant even after being cured. Therefore, ultraviolet-curing gel is more suitable for attaining the object of the present invention. Examples of ultraviolet-curing gel encompass, but not limited to, “TB3168” (product name) and “TB3169” (product name), both of which are manufactured by ThreeBond Co., Ltd.

(a) and (b) of FIG. 6 through FIG. 8 are cross-sectional views each illustrating a portion of the camera module 100 illustrated in FIG. 3, viewed along arrows C-C. Hereinafter, (i) part of the suspension wire 16 which part is connected to the arm part 20a is referred to as a first connected part (fixed end connected to the OIS movable section) 16a, (ii) part of the suspension wire 16 which part is connected to the base 19 is referred to as a second connected part (fixed end connected to the OIS fixed section) 16b, and (iii) a region sandwiched between the first connected part 16a and the second connected part 16b is referred to as a flexible part 16c. The flexible part 16c is a part which deflects when the OIS movable section is driven.

In both of the example configurations illustrated in (a) and (b) of FIG. 6, the suspension wire 16 is inserted through a hole 20b which is provided through the arm part 20a of the elastic body 20, and fixed to the arm part 20a by a solder 25 so as to be electrically conductive with the arm part 20a. The suspension wire 16 is fixed to the arm part 20a by the solder 25 in this way, so that the suspension wire 16 and the arm part 20a are firmly connected to each other.

In (a) of FIG. 6, the damper member 24 is provided on an upper surface of the arm part 20a. However, the damper member 24 and the suspension wire 16 are not in contact with each other. Meanwhile, the suspension wire 16 and the elastic body 20 are soldered to each other on an upper-surface side of the elastic body 20 (a side opposite to a side facing the flexible part 16c). However, in this case, the solder 25 may not stay only on the upper-surface side of the elastic body 20. In other words, the solder 25 may flow down to a lower-surface side of the elastic body 20 (the side facing the flexible part 16c) through the hole 20b. This may causes a surface of the flexible part 16c of the suspension wire 16 to have a solder.

In a case where the surface of the suspension wire 16 have a solder, the suspension wire 16 has a reduced spring property. Particularly, adhesion of a solder to the flexible part 16c adversely influences flexibility of the suspension wire 16. Therefore, in some of cases where stress is repeatedly applied to the suspension wire 16, the suspension wires 16 may suffer a brittle fracture.

On the other hand, in (b) of FIG. 6, the damper member 24 is provided on the lower-surface side (the side facing the flexible part 16c) of the elastic body 20. In other words, the damper member 24 is provided on an inner-surface side of the arm part 20a which inner-surface side is located between the first connected part 16a and the second connected part 16b of the suspension wire 16.

Further, the damper member 24 is provided so as to cover part of the flexible part 16c of the suspension wire 16. More specifically, the damper member 24 is provided so as to cover at least part of a circumference of an end part of the flexible part 16c, which end part is on an arm-part-20a side. With the configuration, the damper member 24 suppresses vibration of a root of the flexible part 16c of the suspension wire 16, which root is most likely to suffer a brittle fracture. This allows a reduction in stress acting on the root. It is therefore possible to prevent the suspension wire 16 from being fractured even in a case where the stress is repeatedly applied to the suspension wire 16.

Note that, in the case where the damper member 24 is provided on the lower-surface side of the elastic body 20 (the side facing the flexible part 16c) as illustrated in (b) of FIG. 6, a sheet material can be employed as the damper member 24 and is attached to the arm part 20a. Alternatively, the damper member 24 can be provided in a desired location with ease, by applying a gel material to the arm part 20a and then curing the gel material.

FIG. 7 illustrates another modification in which (i) a damping effect with respect to the arm part 20a is brought about and (ii) a damping effect of preventing a fracture of the suspension wire 16 is brought about. According to the modification illustrated in FIG. 7, (A) the damper member 24 is provided so as to cover the end part of the flexible part 16c of the suspension wire 16 and (B) one end of the damper member 24 is connected to the intermediate retaining member 13. The intermediate retaining member 13 is hardly displaced in the direction of the optical axis during vibration of the arm part 20a. Accordingly, when an end (to which the suspension wire 16 is fixed) of the arm part 20a is displaced in the direction of the optical axis, the damper member 24 acts to suppress a speed of relative displacement between the arm part 20a and the intermediate retaining member 13. As such, the damper member 24 is capable of bringing about a damping effect with respect to the arm part 20a. Furthermore, since the damper member 24 covers the end part of the flexible part 16c, it is possible to obtain a damping effect of preventing a fracture of the suspension wire 16.

Note that, although FIG. 7 appears as if the damper member 24 is assumed to be made of a gel material, the damper member 24 is not limited to gel materials. For example, the damper member 24 can be a sheet-like damper member 24. Also note that the damper member 24 and the intermediate retaining member 13 are preferably connected to each other with a certain degree of strength, rather than simply in contact with each other. For example, a fillet can be provided at a corner part. It is also preferable that a configuration of a region, in which the intermediate retaining member 13 is in contact with the damper member 24, is optimized as needed so that a gel material is applied or a sheet-like damper member 24 is provided with ease. Moreover, in a case where a gel material is used as the damper member 24, the intermediate retaining member 13 can be provided with a receiving part 13a (e.g. a step) for facilitating application of the damper member 24 so that the gel material, which has not been cured, is prevented from flowing and adhering to a part to which the damper member 24 does not need to be provided (see FIG. 8).

The above description has discussed the case where the suspension wire 16 is fixed to the arm part 20a with the use of the solder 25. Embodiment 1 is, however, not limited to such. For example, the damper member 24 can be provided on a lower surface (facing the flexible part 16c) of the arm part 20a so that the damper member 24 covers at least part of an end part (on an arm-part-20a side) of the flexible part 16c. With the configuration, the damper member 24 suppresses vibration of a root of the flexible part 16c of the suspension wire 16. This allows a reduction in stress acting on the root. It is therefore possible to prevent the suspension wire 16 from being fractured even in a case where the stress is repeatedly applied to the suspension wire 16, regardless of whether or not a solder is used.

(Resonance)

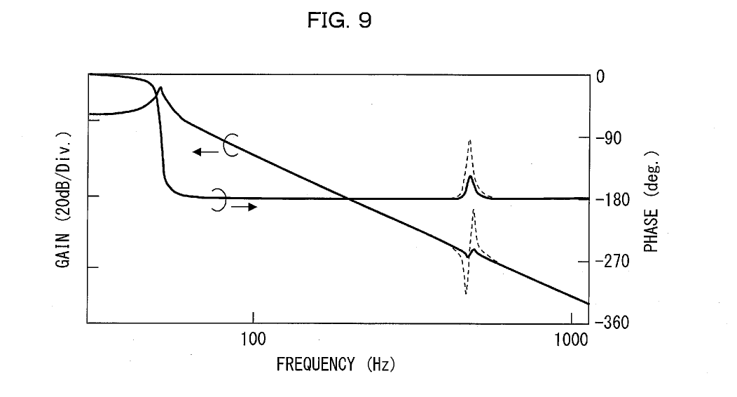

A solution to the risk of oscillation of the servo system in the camera module 100 will be described below in more detail with reference to FIG. 9. FIG. 9 is a Bode diagram illustrating an example frequency characteristic of movement in an image stabilization direction during servo driving for image stabilization in the camera module 100.

In the configuration where various springs are used to support the OIS movable section as in Embodiment 1, a resonance occurs at a frequency which is determined depending on a spring constant of each of the springs and mass of the OIS movable section. In a case where a position to which a drive force for driving the OIS movable section is applied is not aligned with the barycentric position of the OIS movable section, the OIS movable section is subjected to a rotational moment. This may result in a larger resonance peak.

A resonance peak observed at a frequency of approximately 600 Hz indicates a resonance in a rotational mode, which resonance is caused by a structure of a fixing part of an arm part 20a and a suspension wire 16. Broken lines indicate frequency characteristics in a case where no damper member 24 is applied to the elastic body 20 (arm part 20a), which characteristics each have a remarkably large resonance peak. Note that a cutoff frequency of the servo system for image stabilization is usually set to about 100 Hz to 200 Hz. Thus, the frequency of approximately 600 Hz, at which the resonance occurs, is higher than the cutoff frequency. The phase of the servo system is delayed at a frequency of approximately 600 Hz by substantially 180 degrees or more. In a case where there exists a large resonance peak in this frequency band, an insufficient gain margin occurs, and therefore the servo system is at risk of oscillation. The solid lines in FIG. 9 indicate frequency characteristics obtained in a case where the damper member 24 is applied to the elastic body 20 (arm part 20a). As is clear from FIG. 9, since the resonance peak is well suppressed, a gain margin can be secured in the frequency band. This allows a more stable servo system to be achieved.

The camera module 100 is thus configured. However, the configuration of the camera module 100 is not limited to the above configuration. The description of Embodiment 1 by no means is intended to limit a coil form and a structure of a magnetic circuit. The description of Embodiment 1 is also not intended to add any limitation to new ideas for reduction in size and/or weight, thrust enhancement, and/or the like.

### Embodiment 2

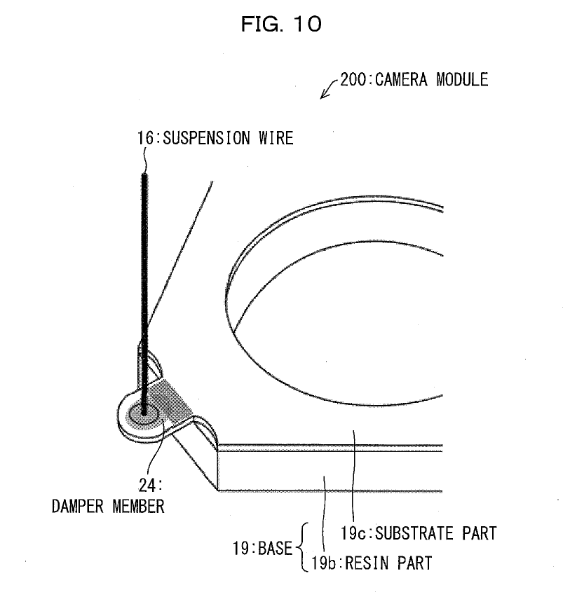

The following description will discuss, with reference to FIG. 10, a camera module 200 in accordance with Embodiment 2 of the present invention. Note that, for convenience, identical reference numerals will be given to respective members having functions identical to those of members described in Embodiment 1, and the members will not be described here. FIG. 10 is a perspective view schematically illustrating a configuration of the camera module 200.

Embodiment 2 is different from Embodiment 1 in the following point.

According to Embodiment 1, the elastic body 20 is used to suppress stress applied to each of the suspension wires 16. In addition to that, according to Embodiment 2, a base 19 which is an OIS fixed section and which is connected to suspension wires 16 has a double-layered structure so as to suppress stress applied to each of the suspension wires 16. Specifically, the base 19 has a double-layered structure in which a resin part 19b and a substrate part 19c (flexible part), each of which is a fixed part, are layered on each other. This allows the substrate part 19c to function as an elastic body, thereby allowing stress, applied to each of the suspension wires 16, to be further suppressed. This will be described below in more detail.

According to Embodiment 2, the base 19 has the resin part 19b and the substrate part 19c. The base 19 has a double-layered structure in which the resin part 19b is layered, in a direction of an optical axis, under the substrate part 19c (see FIG. 10). In other words, the resin part 19b supports the substrate part 19c. Meanwhile, the resin part 19b does not partially support the substrate part 19c so that the base 19 partially has a single-layered structure. This allows the substrate part 19c to have flexible portions (not illustrated) each having flexibility. Therefore, by fixing each of the suspension wires 16 to a corresponding one of the flexible portions, it is possible to cause the corresponding one of the flexible portions to function as an elastic body for suppressing stress applied to the each of the suspension wires 16.

As with the case of arm parts 20a, examples of a material of the substrate part 19c, used as an elastic body for suppressing stress applied to each of the suspension wires 16, encompass, but not limited to, metal and plastic. The substrate part 19c is more preferably made of a material which allows a spring constant to be sufficiently low and which is not plastically-deformed even in a case of being deformed by approximately 150 μm. In a case where the substrate part 19c is soldered to the suspension wires 16, the substrate part 19c is preferably made of metal. Alternatively, as the substrate part 19c, a metal-patterned circuit substrate (glass epoxy substrate or the like) can be used.

As with the case of Embodiment 1, it is possible to further reduce a risk of oscillation of a servo system by providing damper members 24 to the respective flexible portions of the substrate part 19c for suppressing stress applied to each of the suspension wires 16.

### Embodiment 3

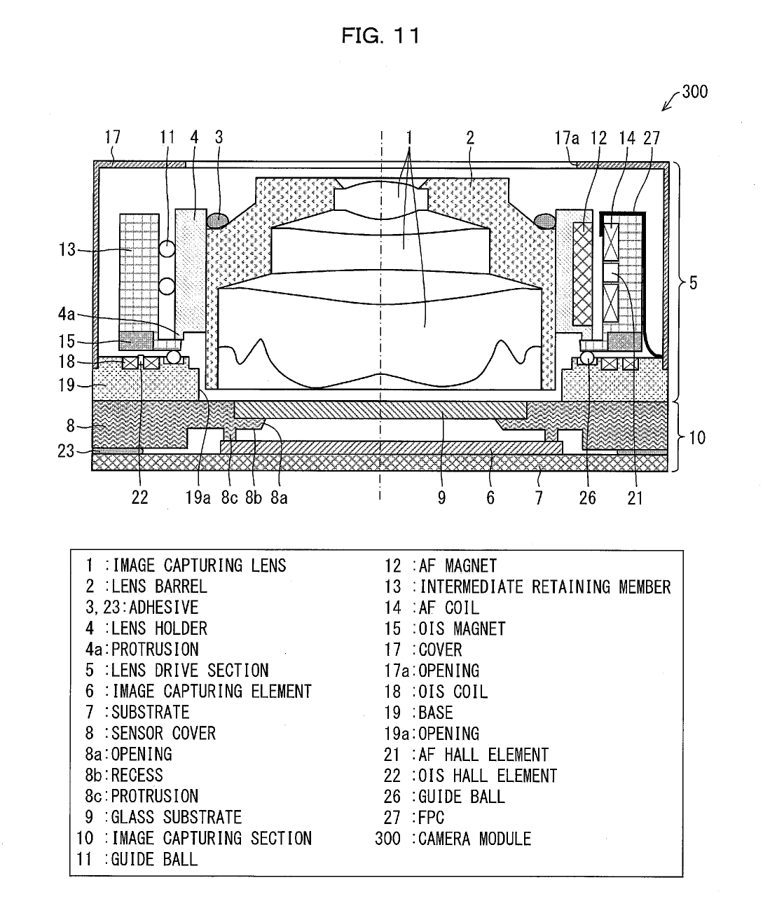

The following description will discuss, with reference to FIG. 11, a camera module 300 in accordance with Embodiment 3 of the present invention Note that, for convenience, identical reference numerals will be given to respective members having functions identical to those of members described in Embodiment 1, and the members will not be described here. FIG. 11 is a cross-sectional view schematically illustrating a configuration of the camera module 300.

Embodiment 3 is different form Embodiment 1 in the following point.

According to Embodiment 1, the suspension wires 16 are used as means for supporting the OIS movable section. In contrast, according to Embodiment 3, guide balls 26 are used as means for supporting an OIS movable section. This configuration allows a risk of damage to a suspension wire which damage is caused by a drop impact to be prevented. This will be described below in more detail.

According to the camera module 300, the guide balls 26 (OIS guide balls) are provided so as to be sandwiched between an intermediate retaining member 13 and a base 19. The camera module 300 is configured such that, by the guide balls 26 rolling, the OIS movable section is supported so as to be displaceable in a surface direction perpendicular to an optical axis.

Note, here, that the guide balls 26 do not always need to be provided between the base 19 and the intermediate retaining member 13 so as to be arranged along each of sides of an upper surface of the base 19. For example, a single row of the guide balls 26 (two or three guide balls 26) can be provided between the base 19 and the intermediate retaining member 13 so as to be arranged along one of the sides. Alternatively, two rows of the guide balls 26 can be provided between the base 19 and the intermediate retaining member 13 so as to be arranged along one of the sides.

According to the camera module 300, since no suspension wire 16 is used as means for supporting the OIS movable section, an FPC 27 (flexible printed circuit board) is provided as electrifying means for electrifying an AF coil 14, an AF Hall element 21, an AF control element, and the like. One of ends of the FPC 27 is connected to wiring for a control signal, which wiring includes the AF coil 14 and the AF Hall element 21. The other one of the ends of the FPC 27 is connected to, for example, a substrate of the camera module 300. According to Embodiment 3, the FPC 27 is necessary as the electrifying means. However, by supporting the OIS movable section with use of the guide balls 26, it is possible to prevent a risk of damage to a suspension wire 16 which damage is caused by a drop impact. Therefore, in a case where, for example, an image capturing lens 1 is large in size and the OIS movable section is accordingly great in weight, it is possible to reduce a risk of damage to the camera module by supporting the OIS movable section with use of the guide balls 26 rather than suspension wires 16.

### Embodiment 4

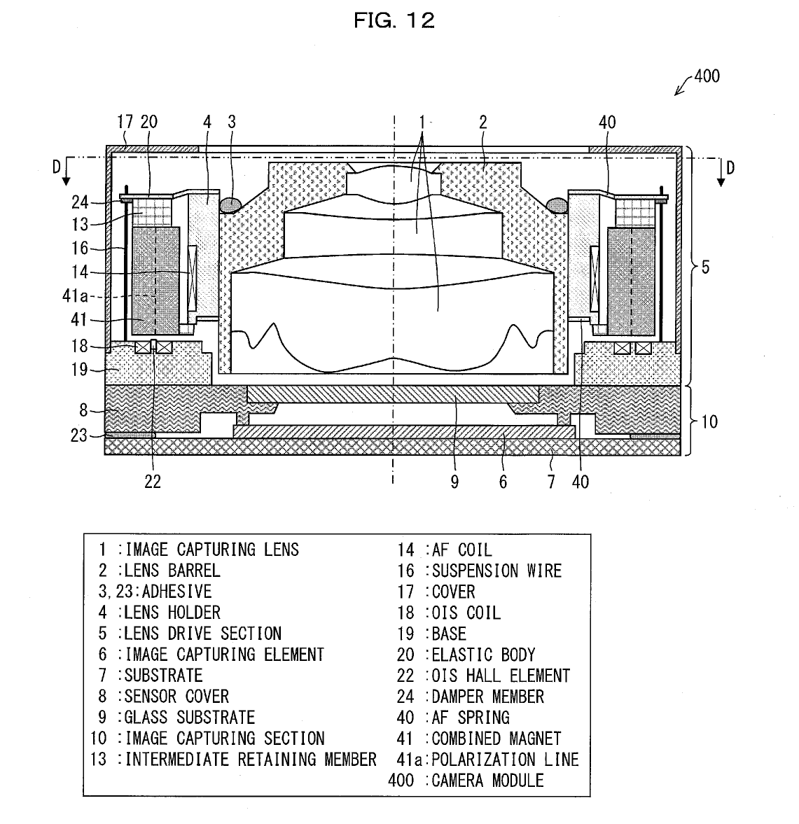

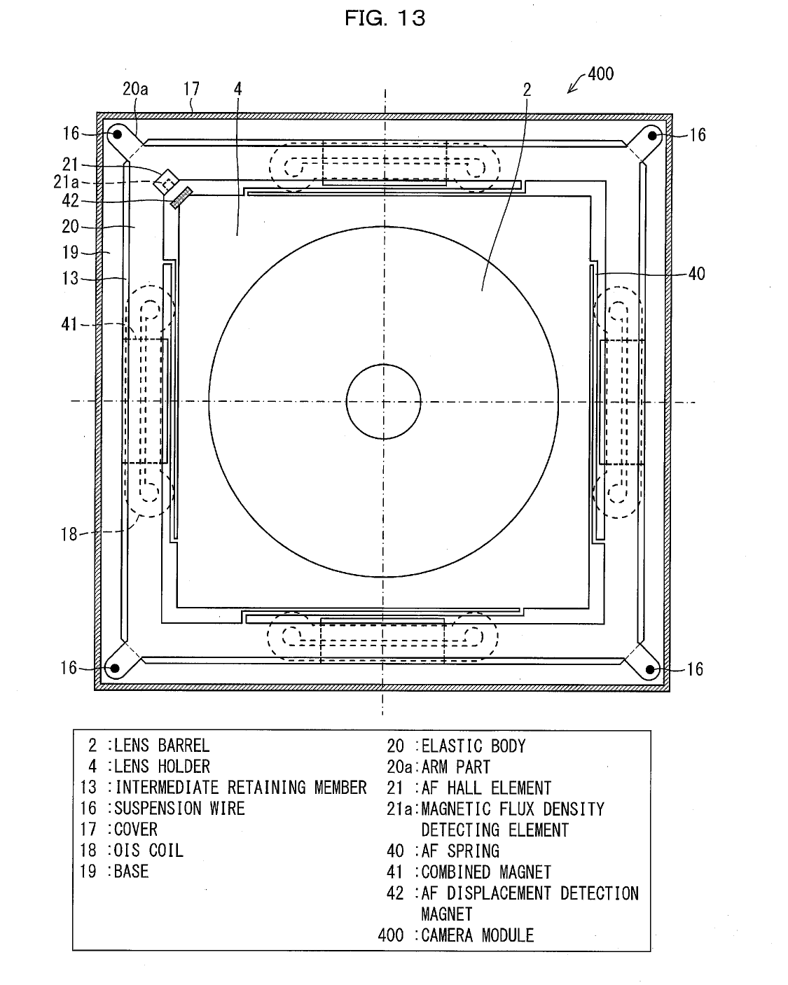

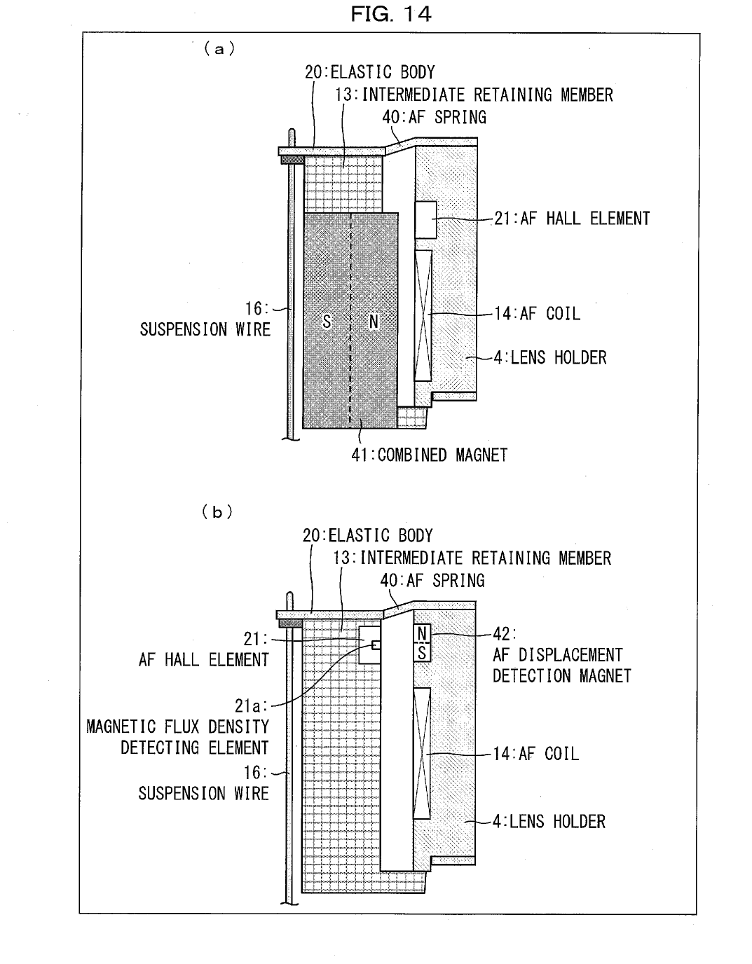

The following description will discuss, with reference to FIGS. 12 through 14, a camera module 400 in accordance with Embodiment 4 of the present invention. Note that, for convenience, identical reference numerals will be given to respective members having functions identical to those of members described in Embodiment 1, and the members will not be described here. FIG. 12 is a cross-sectional view schematically illustrating a configuration of the camera module 400. FIG. 13 is a cross-sectional view illustrating the camera module 400 illustrated in FIG. 12, viewed along arrows D-D. (a) of FIG. 14 is a view illustrating an example in which (i) no AF displacement detection magnet 42 is provided and (ii) an AF Hall element 21 is provided so as to face a combined magnet 41. (b) of FIG. 14 is a view illustrating an example in which (i) an AF displacement detection magnet 42 is provided and (ii) a magnetic flux density detecting element 21a of an AF Hall element 21 is provided so as to face the AF displacement detection magnet 42.

Embodiment 4 is different form Embodiment 1 in the following points.

According to Embodiment 1, the guide balls 11 are used as means for supporting the lens holder 4 so that the lens holder 4 is displaceable in the direction of the optical axis with respect to the intermediate retaining member 13.

However, the means for supporting the lens holder 4 so that the lens holder 4 is displaceable in the direction of the optical axis with respect to the intermediate retaining member 13 is not limited to the guide balls 11. The camera module 400 includes AF springs 40, instead of the guide balls 11 of the camera module 100 in accordance with Embodiment 1 (see FIGS. 12 and 13).

Furthermore, according to Embodiment 1, the camera module 100 includes (i) the AF magnet 12 as an AF drive magnet which causes the AF movable section to be driven and (ii) the OIS magnets 15 as OIS drive magnets each of which causes the OIS movable section to be driven. According to Embodiment 1, the AF magnet 12 functions as an autofocus displacement detection magnet for causing displacement of the AF movable section, which displacement results from autofocusing, to be detected, whereas each of the OIS magnets 15 functions as an image stabilization displacement detection magnet for causing displacement of the OIS movable section, which displacement results from image stabilization, to be detected.

In contrast, the camera module 400 includes the combined magnets 41 as drive magnets, instead of the AF magnet 12 and OIS magnets 15 of the camera module 100. Each of the combined magnets 41 serves as both of an AF drive magnet and an OIS drive magnet. The camera module 400 further includes, in addition to the combined magnets 41 serving as drive magnets, the AF displacement detection magnet 42 as an autofocus displacement detection magnet. Each of the combined magnets 41 is thus used as a drive magnet and as an image stabilization displacement detection magnet, although the each of the combined magnets 41 is not used as an autofocus displacement detection magnet.

That is, an AF movable section in accordance with Embodiment 4 includes image capturing lenses 1, a lens barrel 2, an adhesive 3, a lens holder 4, an AF coil 14, and the AF displacement detection magnet 42. Note that, also in Embodiment 4, an intermediate retaining member 13 functions as an AF fixed section. Meanwhile, an OIS movable section in accordance with Embodiment 4 includes the AF movable section, the AF springs 40, an elastic body 20, the intermediate retaining member 13, and the combined magnets 41. Note that, also in Embodiment 4, a base 19 functions as an OIS fixed section.

As illustrated in FIG. 12, the AF springs 40 are provided on each of upper and lower ends of the intermediate retaining member 13. One of ends of an AF spring 40 provided on the upper end of the intermediate retaining member 13 is connected to the intermediate retaining member 13, and the other one of the ends of the AF spring 40 is connected to an upper end of the lens holder 4. Meanwhile, one of ends of an AF spring 40 provided on the lower end of the intermediate retaining member 13 is connected to the intermediate retaining member 13, and the other one of the ends of the AF spring 40 is connected to a lower end of the lens holder 4. According to Embodiment 4, the lens holder 4 is supported, by pairs of AF springs 40 each of which pairs is made up of (i) the AF spring 40 provided on the upper end of the intermediate retaining member 13 and (ii) the AF spring 40 provided on the lower end of the intermediate retaining member 13, so as to be displaceable in a direction of an optical axis with respect to the intermediate retaining member 13.

Note that the AF springs 40 provided on the upper end of the intermediate retaining member 13 are integrated with the elastic body 20 as illustrated in FIGS. 12 and 13. This allows a single member to function as a support for the lens holder 4 and as a shock-absorber for suspension wires 16.

Each of the combined magnets 41 is a magnet that functions as both of the AF magnet 12 and one of the OIS magnets 15 which are used in Embodiment 1, and is used as a drive magnet (magnetic drive means) which causes the AF movable section and the OIS movable section to be magnetically driven. The combined magnets 41 are fixed to respective four sides of the intermediate retaining member 13 so as to be arranged along the respective four sides. According to Embodiment 4, the AF coil 14 is fixed to outer peripheral surfaces of the lens holder 4 while being wound around the outer peripheral surfaces. The combined magnets 41 are fixed at respective positions on the intermediate retaining member 13 which positions face the AF coil 14 and respective OIS coils 18.

The AF Hall element 21 includes therein the magnetic flux density detecting element 21a (see FIG. 13 and (b) of FIG. 14). The AF Hall element 21 detects, by use of the magnetic flux density detecting element 21a, a change in magnetic flux density which change is caused by movement (AF displacement) of the AF displacement detection magnet 42. Thereby, the AF Hall element 21 detects displacement of the AF movable section in the direction of the optical axis. The camera module 400 carries out feedback control during AF driving in accordance with a result of detection of the displacement of the AF movable section.

The AF Hall element 21 is provided between adjacent ones of the combined magnets 41 so as to be apart from the combined magnets 41. Specifically, as illustrated in FIG. 13, the combined magnets 41 are provided so as to be arranged along the respective four sides of the intermediate retaining member 13, and the AF Hall element 21 is provided on one of corners of an inner surface of the intermediate retaining member 13.

The AF displacement detection magnet 42 is provided at a position on the lens holder 4 which position faces the magnetic flux density detecting element 21a. Specifically, as illustrated in FIG. 13, the AF displacement detection magnet 42 is fixed to one of corners of an outer surface of the lens holder 4 which one faces the one of the corners of the intermediate retaining member 13 on which one the magnetic flux density detecting element 21a is provided. The AF displacement detection magnet 42 is provided on the lens holder 4 so as to always face the magnetic flux density detecting element 21a even in a case where the lens holder 4 is displaced in the direction of the optical axis. In other words, the AF displacement detection magnet 42 is provided so as to face, within a range in which the lens holder 4 is movable, the magnetic flux density detecting element 21a.

Note, here, that, as illustrated in FIG. 2, the AF magnet 12 of the camera module 100 in accordance with Embodiment 1 is configured such that a magnetic pole on an image-capturing-section-10 side of a polarization line 12a is different from that on an opening-17a side of the polarization line 12a. Moreover, each of the OIS magnets 15 is configured such that a magnetic pole on an image-capturing-lens-1 side of a polarization line 15a is different from that on a suspension-wire-16 side of the polarization line 15a.

In contrast, each of the combined magnets 41 of the camera module 400 in accordance with Embodiment 4 is configured such that a magnetic pole on an image-capturing-lens-1 side of a polarization line 41a is different from that on a suspension-wire-16 side of the polarization line 41a (see FIG. 12). Note that, as with the case of Embodiment 1, the OIS coils 18 are fixed at respective positions on the base 19 which positions face the respective combined magnets 41.

With such a configuration, by supplying an electric current to the AF coil 14, an electromagnetic force generated between the AF coil 14 and each of the combined magnets 41 causes the AF movable section to be driven in the direction of the optical axis.

Meanwhile, by supplying an electric current to each of the OIS coils 18, an electromagnetic force generated between the each of the OIS coils 18 and a corresponding one of the combined magnets 41 causes the OIS movable section to be driven in two directions each of which is perpendicular to the optical axis.

Here, providing the AF displacement detection magnet 42 in addition to the combined magnets 41 causes an increase in degree of freedom of a space in which the magnetic flux density detecting element 21a, to be provided at the position which faces the AF displacement detection magnet 42, is provided.

According to Embodiment 1, the AF Hall element 21 can be provided only at a limited position such as a middle part of the coiled part of the AF coil 14. Therefore, the AF Hall element 21 is provided at a position close to the AF coil 14. This causes a magnetic field, generated by the AF coil 14 which is supplied with an electric current, to easily enter the AF Hall element 21. As a result, the magnetic field can be noise for an AF displacement detection signal.

In contrast, by providing the AF displacement detection magnet 42 in addition to the combined magnets 41 as in Embodiment 4, the magnetic flux density detecting element 21a does not need to be provided so as to face the combined magnets 41. This causes an increase in degree of freedom of the space in which the magnetic flux density detecting element 21a is provided. Since it is accordingly possible to provide the magnetic flux density detecting element 21a at a position distant from the combined magnets 41 and from the AF coil 14, it is possible to reduce (i) a magnetic interference from each of the combined magnets 41 and (ii) an effect of a magnetic field generated by the AF coil 14.

In this case, it is preferable that, when the camera module 400 is viewed from a direction perpendicular to lens surfaces of the image capturing lenses 1 (that is, viewed from the above), (i) each of the combined magnets 41 be provided at the middle of and along a corresponding one of the four sides of the intermediate retaining member 13, (ii) the magnetic flux density detecting element 21a be provided on one of the corners of the intermediate retaining member 13, and (iii) the AF displacement detection magnet 42 be provided on one of the corners of the lens holder 4. In other words, each of the magnetic flux density detecting element 21a and the AF displacement detection magnet 42 is provided preferably on a line substantially intermediate between adjacent ones of the combined magnets 41, more preferably on a line intermediate between the adjacent ones of the combined magnets 41.

By thus providing the magnetic flux density detecting element 21a at a position on the line substantially intermediate between the adjacent ones of the combined magnets 41 (more preferably, a position on the line intermediate between the adjacent ones of the combined magnets 41), it is possible to reduce an effect of a magnetic interference from each of the combined magnets 41, and accordingly possible to achieve highly-accurate or highly-reliable detection of displacement.

Moreover, by providing the AF displacement detection magnet 42 in addition to the combined magnets 41, it is possible to increase sensitivity of the AF Hall element 21 (magnetic flux density detecting element 21a) in detection of displacement.

This will be described below in detailed with reference to (a) and (b) of FIG. 14.

As illustrated in (a) of FIG. 14, in a case where (i) no AF displacement detection magnet 42 is provided and (ii) an AF Hall element 21 is provided so as to face a combined magnet 41, only a north pole or a south pole of the combined magnet 41 faces an AF coil 14. Therefore, only the north pole or the south pole of the combined magnet 41 also faces the AF Hall element 21 which is provided directly above the AF coil 14 so as to face the combined magnet 41. Note that (a) of FIG. 14 illustrates, as an example, a case where the north pole of the combined magnet 41 faces the AF coil 14 and also faces the AF Hall element 21 which is provided so as to face the combined magnet 41. In a case where only the north pole or the south pole of the combined magnet 41 faces the AF Hall element 21 as just described, the AF Hall element 21 detects a magnetic flux incident on the AF Hall element 21 at a substantially right angle. As a result, the AF Hall element 21 detects a slight change in magnetic flux density distribution which change is caused by an AF function. This makes it difficult to sufficiently increase the sensitivity of the AF Hall element 21 in detection of displacement. Note that, in (a) of FIG. 14, even in a case where the combined magnet 41 has the north pole and the south pole in an opposite manner, a similar result is obtained.

Specifically, in a case where the AF Hall element 21 is provided so as to face, for example, the middle of the combined magnet 41, a change in magnetic flux incident on the AF Hall element 21, which change is caused by the AF function, is very small. In a case where the AF Hall element 21 is provided so as to face an edge of the combined magnet 41 as illustrated in (a) of FIG. 14, the AF Hall element 21 has high sensitivity in detection of displacement made in a direction in which the AF Hall element 21 does not face the combined magnet 41 (i.e., an upper direction in (a) of FIG. 14). Meanwhile, the AF Hall element 21 has low sensitivity in detection of displacement made in the other direction (i.e., a lower direction in (a) of FIG. 14). This causes a deterioration in linearity of detection of displacement. Therefore, it is difficult to sufficiently increase the sensitivity of the AF Hall element 21 in detection of displacement.

In contrast, as illustrated in (b) of FIG. 14, in a case where (i) the AF displacement detection magnet 42 is provided in addition to the drive magnets and (ii) the AF Hall element 21 (specifically, the magnetic flux density detecting element 21a of the AF Hall element 21) is provided so as to face the AF displacement detection magnet 42, there is freedom of arrangement and a direction of the AF displacement detection magnet 42. Therefore, it is possible to cause a polarization surface of a north pole and a south pole to face, within the range in which the lens holder 4 is movable, the magnetic flux density detecting element 21a.

Since the magnetic flux density detecting element 21a thus faces the polarization line 41a, there is basically no magnetic flux incident on the magnetic flux density detecting element 21a at a right angle, and accordingly the magnetic flux density detecting element 21a is capable of detecting a magnetic flux which is substantially parallel to the magnetic flux density detecting element 21a. Therefore, at a position at which the magnetic flux density detecting element 21a faces the polarization line 41a, a Hall voltage (output voltage) of the AF Hall element 21, which Hall voltage is in proportion to a magnetic flux density, is 0 (zero) V. Thereafter, in a case where the AF displacement detection magnet 42 is displaced relative to the magnetic flux density detecting element 21a due to the AF function, the magnetic flux starts to be incident on the magnetic flux density detecting element 21a at a right angle, and a displacement detection signal corresponding to a Hall voltage is outputted. As a result, the sensitivity of the AF Hall element 21 (magnetic flux density detecting element 21a) in detection of displacement is increased. Furthermore, since a change in magnetic flux density is symmetric with respect to the direction of the optical axis, the linearity of the detection of displacement is improved.

Note that four electrifying means are needed for the AF Hall element 21 fixed to the intermediate retaining member 13. The four electrifying means can be realized by providing an FPC as described in Embodiment 3 or alternatively by increasing the number of the suspension wires 16.

Note also that two electrifying means are needed for the AF coil 14 fixed to the lens holder 4. The two electrifying means can be realized by connecting the AF coil 14 to the suspension wires 16 via the AF springs 40. Out of the AF springs 40, a pair of AF springs 40 can be used for the two electrifying means. Alternatively, in a case where only the AF springs 40 provided on the upper end of the lens holder 4 are used for the two electrifying means, the AF springs 40 provided on the upper end of the lens holder 4 can be divided into two so as to be electrically separated.

Note that, even in a case where the AF magnet 12 and the OIS magnets 15 are used, instead of the combined magnets 41, as drive magnets, a similar effect is obtained by providing the AF displacement detection magnet 42 in addition to the AF magnet 12 and the OIS magnets 15. In other words, a similar effect is obtained by arranging, for example, any one of the camera modules 100, 200, and 300 so as to (i) further include the AF displacement detection magnet 42 in addition to the AF magnet 12 and the OIS magnets 15 and (ii) change in position of the AF Hall element 21 as described above.

Note that, in a case where the AF magnet 12 and the OIS magnets 15 are individually provided, instead of the combined magnets 41, as drive magnets, a plurality of AF magnets 12 do not always need to be provided, and at least one AF magnet 12 only needs to be provided as illustrated in, for example, FIG. 3. Note that, even in a case where the AF magnet 12 and the OIS magnets 15 are individually provided as drive magnets, a plurality of AF magnets 12 can be obviously provided as well as the OIS magnets 15.

Note that FIG. 13 and (b) of FIG. 14 each illustrate a case where (i) the AF displacement detection magnet 42 is provided on a lens-holder-4 side and (ii) the AF Hall element 21 (magnetic flux density detecting element 21) is provided on an intermediate-retaining-member-13 side. However, the camera module 400 is not limited to such. The AF displacement detection magnet 42 and the AF Hall element 21 can be provided in an opposite manner. That is, the AF displacement detection magnet 42 can be provided on the intermediate-retaining-member-13 side, and the AF Hall element 21 can be provided on the lens-holder-4 side.

Note, however, that, in a case where the AF Hall element 21 is provided on the intermediate-retaining-member-13 side, there is no need to provide, between the lens holder 4 and the intermediate retaining member 13, electrifying means for electrifying the AF Hall element 21. Therefore, in a case where the AF Hall element 21 is provided on the intermediate-retaining-member-13 side, the camera module can be assembled more easily.

Note that, even in a case where the AF displacement detection magnet 42 is provided on the intermediate-retaining-member-13 side and the AF Hall element 21 is provided on the lens-holder-4 side, the drive magnets are provided on the intermediate-retaining-member-13 side.

Note also that (b) of FIG. 14 illustrates, as an example, a case where, while the image capturing lenses 1 are being located at an infinity end, the magnetic flux density detecting element 21a is provided at a position which faces a polarization line 12a of the AF displacement detection magnet 42. However, Embodiment 4 is not limited to such. For example, in a case where the magnetic flux density detecting element 21a is provided, at a middle position of the range in which the lens holder 4 is movable (that is, a middle position of an AF stroke of the lens holder 4), so as to face the polarization line 12a of the AF displacement detection magnet 42, a displacement detection signal having a negative or a positive voltage with respect to 0 (zero) V is obtained. This makes it easier to obtain the linearity in a broader range.

Note that a configuration illustrated in (b) of FIG. 14 is merely preferable to that illustrated in (a) of FIG. 14, and the configuration illustrated in (a) of FIG. 14 does not deny all the matters within the scope of the claims. Similarly, although Embodiment 4 describes, as an example, a case where the AF displacement detection magnet 42 is provided on the line (position) intermediate between adjacent ones of the combined magnets 41 used as drive magnets, such a case is merely preferable, and a configuration such that the AF displacement detection magnet 42 is provided close to the drive magnets does not deny all the matters within the scope of the claims.

### Embodiment 5

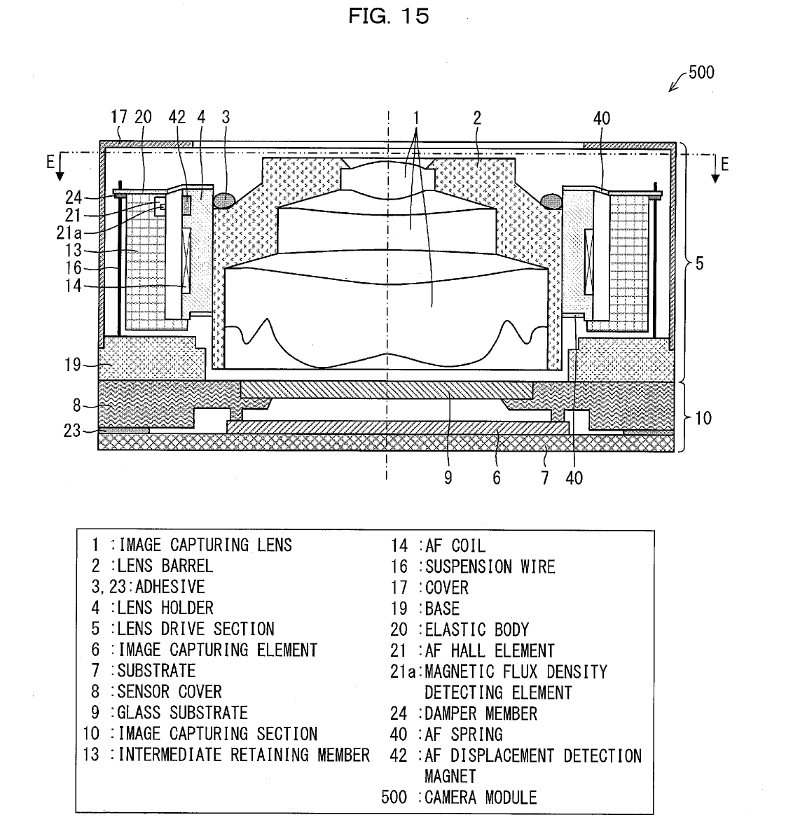

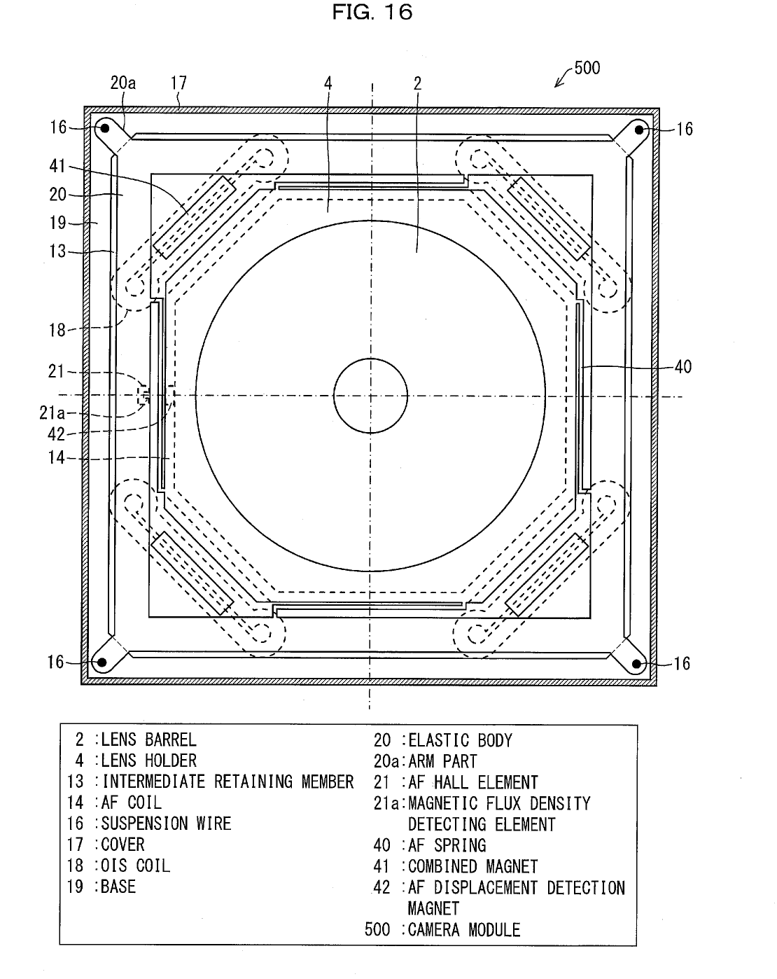

The following description will discuss, with reference to FIGS. 15 and 16, a camera module 500 in accordance with Embodiment 5 of the present invention. Note that, for convenience, identical reference numerals will be given to respective members having functions identical to those of members described in Embodiment 4, and the members will not be described here. FIG. 15 is a cross-sectional view schematically illustrating a configuration of the camera module 500. FIG. 16 is a cross-sectional view illustrating the camera module illustrated in FIG. 15, viewed along arrows E-E.

Embodiment 5 is different form Embodiment 4 in the following points.

According to Embodiment 4, when the camera module 400 is viewed from the direction perpendicular to the lens surfaces of the image capturing lenses 1 (that is, viewed from the above), the combined magnets 41 are fixed, as drive magnets, to the respective four sides of the intermediate retaining member 13 so as to be arranged along the respective four sides. Furthermore, according to Embodiment 4, when viewed from the above, (i) the magnetic flux density detecting element 21a is fixed to one of the corners of the inner surface of the intermediate retaining member 13 and (ii) the AF displacement detection magnet 42 is fixed to one of the corners of the outer surface of the lens holder 4 which one faces the magnetic flux density detecting element 21a.

In contrast, according to the Embodiment 5, combined magnets 41 and an AF Hall element 21 are provided in an opposite manner. That is, according to Embodiment 5, when viewed from the above, the combined magnets 41 are fixed to respective four corners of an intermediate retaining member 13, and the AF Hall element 21 (magnetic flux density detecting element 21a) is fixed to one of four sides of an inner surface of the intermediate retaining member 13 (see, for example, FIG. 16). Accordingly, when viewed from the above, an AF displacement detection magnet 42 is provided at a position on one of four sides of an outer surface of a lens holder 4 which position faces the magnetic flux density detecting element 21a (see, for example, FIG. 16).

According to the above configuration, also in Embodiment 5, it is possible to provide the AF displacement detection magnet 42 in addition to the combined magnets 41. Therefore, the magnetic flux density detecting element 21a does not need to be provided so as to face any of the combined magnets 41. This increases a degree of freedom of arrangement of the magnetic flux density detecting element 21a.

Furthermore, also in Embodiment 5, the magnetic flux density detecting element 21a is provided between, for example, adjacent ones of the combined magnets 41 so as to be apart from the combined magnets 41. As a result, it is possible to reduce (i) a magnetic interference from each of the combined magnets 41 and (ii) an effect of a magnetic field generated by an AF coil 14.

Moreover, also in Embodiment 5, each of the magnetic flux density detecting element 21a and the AF displacement detection magnet 42 is preferably located on a line substantially intermediate between the adjacent ones of the combined magnets 41, more preferably on a line intermediate between the adjacent ones of the combined magnets 41. Specifically, as illustrated in FIG. 16, when viewed from the above, the combined magnets 41 are preferably fixed to the respective four corners of the intermediate retaining member 13, and the magnetic flux density detecting element 21a is preferably fixed to (substantially) the middle of one of the four sides of the inner surface of the intermediate retaining member 13. This makes it possible to reduce an effect of a magnetic interference from each of the combined magnets 41, and accordingly possible to achieve highly-accurate or highly-reliable detection of displacement.

Note that how to provide the AF Hall element 21 (magnetic flux density detecting element 21a), the combined magnets 41, and the AF displacement detection magnet 42, each of which is described in each of Embodiments 4 and 5, can be determined as appropriate, as a design matter in consideration of a size or the like of a lens drive section 5.

In general, in a case where, as described in Embodiment 4, (i) each of the combined magnets 41 is provided at the middle of a corresponding one of the four sides of the intermediate retaining member 13 so as to be arranged along the corresponding one of the four sides and (ii) the magnetic flux density detecting element 21a is provided on one of the four corners of the intermediate retaining member 13 or one of the four corners of the lens holder 4, it is possible to easily reduce a size of the camera module. Therefore, such a case is suitable for a small-sized module. In a case where, as described in Embodiment 5, (i) the combined magnets 41 are provided on the respective four corners of the intermediate retaining member 13 and (ii) the magnetic flux density detecting element 21a is provided at the middle of one of the four sides of the intermediate retaining member 13 or at the middle of one of the four sides of the lens holder 4, such a case is suitable for a large-sized module. Those cases can be selected in consideration of various conditions

Note that, also in Embodiment 5, as with the case of Embodiment 4, even in a case where AF magnet 12 and OIS magnets 15 are used, instead of the combined magnets 41, as drive magnets, a similar effect is obtained by providing the AF displacement detection magnet 42 in addition to the AF magnet 12 and the OIS magnets 15. In other words, a similar effect is obtained by arranging, for example, any one of the camera modules 100, 200, and 300 so as to (i) further include the AF displacement detection magnet 42 in addition to the AF magnet 12 and the OIS magnets 15 and (ii) change in position of the AF Hall element 21 as described above.

Note that, also in Embodiment 5, in a case where the AF magnet 12 and the OIS magnets 15 are individually provided, instead of the combined magnets 41, as drive magnets, a plurality of AF magnets 12 do not always need to be provided, and at least one AF magnet 12 only needs to be provided as illustrated in, for example, FIG. 3. Note that, even in a case where the AF magnet 12 and the OIS magnets 15 are individually provided as drive magnets, a plurality of AF magnets 12 can be obviously provided as well as the OIS magnets 15.

Note that, also in Embodiment 5, (i) the AF displacement detection magnet 42 is provided on a lens-holder-4 side and (ii) the AF Hall element 21 (magnetic flux density detecting element 21) is provided on an intermediate-retaining-member-13 side, as illustrated in FIGS. 15 and 16. However, the camera module 500 is not limited to such. The AF displacement detection magnet 42 and the AF Hall element 21 can be provided in an opposite manner. That is, the AF displacement detection magnet 42 can be provided on the intermediate-retaining-member-13 side, and the AF Hall element 21 can be provided on the lens-holder-4 side.

Note, however, that, as has been described above, in a case where the AF Hall element 21 is provided on the intermediate-retaining-member-13 side, there is no need to provide, between the lens holder 4 and the intermediate retaining member 13, electrifying means for electrifying the AF Hall element 21. Therefore, in a case where the AF Hall element 21 is provided on the intermediate-retaining-member-13 side, the camera module can be assembled more easily.

Note that, also in Embodiment 5, even in a case where the AF displacement detection magnet 42 is provided on the intermediate-retaining-member-13 side and the AF Hall element 21 is provided on the lens-holder-4 side, the drive magnets are provided on the intermediate-retaining-member-13 side.

Note that, also in Embodiment 5, as with the case of Embodiment 4, in a case where, for example, the magnetic flux density detecting element 21a is provided, at a middle position of a range in which the lens holder 4 is movable (that is, a middle position of an AF stroke of the lens holder 4), so as to face a polarization line of the AF displacement detection magnet 42, a displacement detection signal having a negative or a positive voltage with reference to 0 (zero) V is obtained (not illustrated). This makes it easier to obtain linearity in a broader range.

### Embodiment 6

The following description will discuss, with reference to FIGS. 17 and 18, a camera module 600 in accordance with Embodiment 6 of the present invention. Note that, for convenience, identical reference numerals will be given to respective members having functions identical to those of members described in Embodiment 4, and the members will not be described here.

(Configuration of Camera Module 600)

First, a configuration of the camera module 600 in accordance with Embodiment 6 will be described below with reference to FIG. 17 and (a) and (b) of FIG. 8.

FIG. 17 is a cross-sectional view schematically illustrating the configuration of the camera module 600 in accordance with Embodiment 6 of the present invention. (a) and (b) of FIG. 18 are cross-sectional views each illustrating the camera module 600 illustrated in FIG. 17, viewed along arrows F-F. Note that (a) of FIG. 18 illustrates a state where an intermediate retaining member 13 is not displaced, and (b) of FIG. 18 illustrates a state where the intermediate retaining member 13 is displaced by, for example, an inertial force caused by a drop impact or disturbance vibration.

Embodiment 6 is different form Embodiment 4 in the following points. That is, according to Embodiment 4, the AF Hall element 21 (AF displacement detecting section 31) is fixed to the intermediate retaining member 13. In contrast, according to Embodiment 6, an AF Hall element 21 is fixed to, via a Hall holder 43 for fixing the AF Hall element 21, one of arm extensions 20c which extend toward an inside of the camera module 600 from respective portions of arm parts 20a of an elastic body 20 to which portions respective suspension wires 16 are fixed.

This will be described below in more detail. Also in Embodiment 6, part of the elastic body 20, fixed to the intermediate retaining member 13, protrudes from a periphery of the intermediate retaining member 13 so as to form the arm parts 20a each having flexibility (see FIG. 17 and (a) and (b) of FIG. 18). Note, however, that, according to Embodiment 6, an arm part 20a is formed by partially narrowing widths of adjacent ones of sides of the elastic body 20, which surrounds a lens holder 4 (see FIG. 17). Therefore, according to Embodiment 6, the arm part 20a is configured such that (i) portions of adjacent ones of the sides of the elastic body 20 extend from the respective other portions (portions other than the arm part 20a) along the respective adjacent ones of the sides and (ii) the portions join together at a connection P (joint) between the elastic body 20 and a suspension wire 16 so as to be integrated.

Note that the arm part 20a, made up of the portions extending from the respective adjacent ones of the sides of the elastic body 20, has a sufficiently narrow width so that the arm part 20a has a low spring constant and is easily bent, as compared with the other part of the elastic body 20.

In addition to the arm parts 20a, the arm extensions 20c extend toward the inside of the camera module 600 from the respective connections P between the arm parts 20a and the suspension wires 16. The AF Hall element 21 is fixed to one of the arm extensions 20c via the Hall holder 43. The AF displacement detection magnet 42 is fixed to the lens holder 4 so as to face the AF Hall element 21.

(Effect of Camera Module 600)

Next, effects of the camera module 600 in accordance with Embodiment 6 will be described below.

In Embodiment 1, it has been described that the intermediate retaining member 13 is supported to the base 19 by the suspension wires 16 and that the intermediate retaining member 13 is displaced in the first direction, which is perpendicular to the optical axis, and the second direction, which is perpendicular to the optical axis and to the first direction, but is not basically displaced in the direction of the optical axis. This description is based on a case where a mobile terminal, such as a mobile phone, on which the camera module is mounted is in normal use (i.e., the mobile terminal is, for example, held by a hand). In this case, as has been described, the intermediate retaining member 13 is hardly displaced in the direction of the optical axis. This is because, in a case where the mobile terminal is in the normal use (for example, the mobile terminal is held by a hand), no high-frequency vibration (for example, vibration having a frequency of hundreds of hertz) is applied to the camera module.

However, in a case where the camera module is mounted on a car or a case where the camera module is fixed to a tripod and vibration from a floor is transmitted to the camera module via the tripod, high-frequency vibration may be applied to the camera module.

As has been described in Embodiment 1, upper ends of the suspension wires 16 are fixed to the respective arm parts 20a of the elastic body 20, and the arm parts 20a each function as a shock-absorber. However, in a case where vibration having a frequency close to a resonant frequency of each of the arm parts 20a is applied to the camera module, the intermediate retaining member 13 may be vibrated in the direction of the optical axis. Specifically, a resonant frequency, determined depending on (i) a spring constant of each of the AF springs 40 and (ii) a weight of the AF movable section made up of the lens holder 4, the lens barrel 2, and the like, is usually around 100 Hz. In a case where the resonant frequency of each of the arm parts 20a is an order of hundreds of hertz (around 200 Hz through 600 Hz), the intermediate retaining member 13 may be vibrated in the direction of the optical axis, because those resonant frequencies are close to each other. In a case where the intermediate retaining member 13 is vibrated in the direction of the optical axis, the AF movable section, such as the image capturing lenses 1, may be also displaced in accordance with vibration, in the direction of the optical axis, of the intermediate retaining member 13.

Therefore, in a case where the AF Hall element 21 is fixed to the intermediate retaining member 13 as in Embodiment 4, it may not be possible to accurately detect displacement of the image capturing lenses 1 which displacement is caused by the intermediate retaining member 13 being vibrated (displaced) in the direction of the optical axis.

In contrast, according to Embodiment 6, the AF Hall element 21 is fixed to (i) one of the connections P between the arm parts 20a of the elastic body 20 and the respective suspension wires 16 (one of portions of the arm parts 20a to which portions the respective suspension wires 16 are fixed) or (ii) one of the arm extensions 20c (extended parts) which extend toward the inside of the camera module 600 from the respective connections P and which are not displaced in the direction of the optical axis.

Even in a case where disturbance vibration is applied to the connections P between the suspension wires 16 and the respective arm parts 20a of the elastic body 20, the connections P are hardly displaced in the direction of the optical axis, unless the suspension wires 16 are expanded or contracted. Therefore, even in a case where the disturbance vibration is applied to the connections P, the AF Hall element 21, fixed to one of the connections P or one of the arm extensions 20c extending from the respective connections P, is also hardly displaced in the direction of the optical axis, unless the suspension wires 16 are expanded or contracted. Therefore, the AF Hall element 21 is capable of detecting, as displacement of the image capturing lenses 1, displacement of the lens holder 4 with respect to an image stabilization fixed section such as a base 19, even in a case where the displacement of the lens holder 4 is caused by displacement of the intermediate retaining member 13 or the displacement of the lens holder 4 is relative displacement of the lens holder 4 with respect to the intermediate retaining member 13.

Furthermore, it is also possible to suppress vibration of the intermediate retaining member 13 by an AF displacement detecting section 31 (i) detecting an amount of displacement, in the direction of the optical axis, of the lens holder 4 (displacement of the image capturing lenses 1) with respect to the image stabilization fixed section and (ii) feeding the amount of the displacement back to an AF driving control section 32. Note, however, that, in order to suppress the vibration of the intermediate retaining member 13 as a servo system, it is necessary to secure a servo band of more than around 100 Hz so as to carry out feedback control with respect to such vibration having a frequency of hundreds of hertz.

This will be described below in detail with reference to (a) and (b) of FIG. 18.

As illustrated in (a) of FIG. 18, in a case where the lens holder 4 is displaced in the direction of the optical axis while no external force is being applied to the intermediate retaining member 13 and therefore the intermediate retaining member 13 is not being displaced in the direction of the optical axis, the AF displacement detection magnet 42 fixed to the lens holder 4 is accordingly displaced together with the lens holder 4. However, the AF Hall element 21 is not displaced. Therefore, the AF Hall element 21 is capable of detecting such relative displacement.

As illustrated in (b) of FIG. 18, also in a case where (i) an external force is applied to the intermediate retaining member 13 so that the intermediate retaining member 13 is displaced in the direction of the optical axis and (ii) the lens holder 4 is accordingly displaced in the direction of the optical axis together with the intermediate retaining member 13, the AF Hall element 21 is hardly displaced. Therefore, it is possible to accurately detect displacement of the lens holder 4.

In short, by providing the AF Hall element 21 as in Embodiment 6, the AF Hall element 21 is, like an image capturing element 6, fixed to a fixed part of the camera module 600. Therefore, in both of (i) a case where the lens holder 4 is displaced in the direction of the optical axis and (ii) a case where the intermediate retaining member 13 is displaced in the direction of the optical axis so that the lens holder 4 is displaced in the direction of the optical axis together with the intermediate retaining member 13, the AF Hall element 21 is capable of accurately detecting, as an amount of displacement of the image capturing lenses 1, an amount of relative displacement, in the direction of the optical axis, of the image capturing lenses 1 with respect to the image capturing element 6. As has been described, even in a case where the camera module 600 receives vibration having a high frequency of an order of hundreds of hertz, it is possible to (i) detect an amount of displacement, in the direction of the optical axis, of the image capturing lenses 1 which displacement has been caused by the vibration, (ii) feed the amount of the displacement of the image capturing lenses 1 back to a control system, and (iii) secure a necessary servo band, thereby suppressing the vibration of the image capturing lenses 1 which vibration has been caused by disturbance vibration. As a result, it is possible to improve an image capturing quality of the camera module 600.

### SUMMARY

A camera module (camera module 100, 200, 300, 400, 500, 600) in accordance with a first aspect of the present invention is a camera module including: an image stabilization fixed section (base 19) including: an image capturing element (6); an image stabilization movable section (image capturing lens 1, lens barrel 2, adhesive 3, lens holder 4, AF magnet 12, guide balls 11, OIS magnets 15, elastic body 20, intermediate retaining member 13, and AF coil 14, and, depending on a camera module (i.e., depending on Embodiment), AF displacement detection magnet 42, combined magnets 41 (instead of the AF magnet 12 and the OIS magnets 15), and AF springs 40 (instead of the guide balls 11)) including: an image capturing lens (1); an autofocus fixed section (intermediate retaining member 13); and an autofocus movable section (image capturing lens 1, lens barrel 2, adhesive 3, and lens holder 4, and, depending on a camera module (i.e., depending on Embodiment), AF magnet 12, AF coil 14, and/or AF displacement detection magnet 42); an autofocus displacement detecting section (AF displacement detecting section 31); an image stabilization displacement detecting section (OIS displacement detecting section 34); an image stabilization driving section (OIS driving section 38); and an autofocus driving section (AF driving section 37), the image capturing element having an axis corresponding to an optical axis of the image capturing lens, the image stabilization fixed section being not displaced in any direction, the image stabilization movable section being displaced, by the image stabilization driving section, in two directions which are each perpendicular to the optical axis and which are perpendicular to each other, with respect to the image stabilization fixed section, the autofocus fixed section being not displaced in a direction of the optical axis, the autofocus movable section being displaced, by the autofocus driving section, in the direction of the optical axis with respect to the autofocus fixed section, the autofocus displacement detecting section detecting displacement of the autofocus movable section in the direction of the optical axis, the image stabilization displacement detecting section detecting displacement of the image stabilization movable section in the two directions which are each perpendicular to the optical axis and which are perpendicular to each other.

According to the above configuration, the camera module includes (i) the autofocus displacement detecting section for detecting displacement of the autofocus movable section in the direction of the optical axis and (ii) the image stabilization displacement detecting section for detecting displacement of the image stabilization movable section in the two directions which are each perpendicular to the optical axis and which are perpendicular to each other. This makes it possible to, in autofocusing and image stabilization, drive the autofocus movable section and the image stabilization movable section by feedback control. As a result, it is possible to increase accuracy of control of triaxial displacement, and accordingly possible to achieve highly-accurate and high-speed autofocusing and image stabilization.

The camera module (camera module 100, 200, 300, 400, 500, 600) in accordance with a second aspect of the present invention can be arranged so as to, in the first aspect, further include: an autofocus driving control section (AF driving control section 32) which controls driving of the autofocus driving section (AF driving section 37); and an image stabilization driving control section (OIS driving control section 35) which controls driving of the image stabilization driving section (OIS driving section 38), the autofocus driving control section controlling the driving of the autofocus driving section by feedback control which is based on a result of detection carried out by the autofocus displacement detecting section (AF displacement detecting section 31), the image stabilization driving control section controlling the driving of the image stabilization driving section by feedback control which is based on a result of detection carried out by the image stabilization displacement detecting section (OIS displacement detecting section 34).

According to the above configuration, the autofocus driving control section and the image stabilization driving control section drives the autofocus driving section and the image stabilization driving section, respectively, by feedback control. As a result, it is possible to improve the accuracy of the control of the triaxial displacement, and accordingly possible to achieve highly-accurate and high-speed autofocusing and image stabilization. Specifically, for example, in autofocusing, it is possible to achieve high-speed autofocusing. In image stabilization, it is possible to increase image stabilization ability and to reduce a residual camera shake in a case where a camera shake occurs.

The camera module (camera module 400, 500) in accordance with a third aspect of the present invention can be arranged such that: in the first or the second aspect, the autofocus driving section (AF driving section 37) includes at least one drive magnet (combined magnets 41 or AF magnet 12) for causing the autofocus movable section to be magnetically driven (note, however, that a combined magnet 41 serves as a drive magnet, the autofocus driving section includes a plurality of combined magnets 41); the autofocus displacement detecting section (AF displacement detecting section 31) includes an magnetic flux density detecting element (21a) which is provided to one of the autofocus movable section (for example, lens holder 4) and the autofocus fixed section (for example, intermediate retaining member 13) so as to be apart from the at least one drive magnet; an autofocus displacement detection magnet (AF displacement detection magnet 42) is provided to the other one of the autofocus movable section and the autofocus fixed section so as to be apart from the at least one drive magnet and so as to face the magnetic flux density detecting element; the magnetic flux density detecting element detects the displacement of the autofocus movable section in the direction of the optical axis in accordance with a change in magnetic flux density of the autofocus displacement detection magnet.

According to the above configuration, the autofocus displacement detection magnet is provided in addition to the drive magnet for causing the autofocus movable section to be driven. This causes an increase in degree of freedom of a space in which the magnetic flux density detecting element, to be provided at a position which faces the autofocus displacement detection magnet, is provided. This allows the magnetic flux density detecting element to be provided at a position apart from the drive magnet and from the autofocus coil. It is therefore possible to reduce (i) a magnetic interference from the drive magnet and (ii) an effect of a magnetic field generated by the autofocus coil, and accordingly possible to achieve highly-accurate or highly-reliable detection of displacement.

Further, according to the above configuration, even in a case where the magnetic flux density detecting element is provided to any one of the autofocus movable section and the autofocus fixed section, the autofocus displacement detection magnet is provided so as to face the magnetic flux density detecting element. That is, the autofocus displacement detection magnet is provided to one of the autofocus movable section and the autofocus fixed section to which one the magnetic flux density detecting element is not provided, so as to always face the magnetic flux density detecting element even in a case where the autofocus movable section is displaced in the direction of the optical axis. In other words, the magnetic flux density detecting element is provided to the any one of autofocus movable section and the autofocus fixed section, and the autofocus displacement detection magnet is provided to the other one of the autofocus movable section and the autofocus fixed section so as to face, within a range in the direction of the optical axis in which range the autofocus movable section is movable, the magnetic flux density detecting element.

By thus providing the autofocus displacement detection magnet so as to face the magnetic flux density detecting element, it is possible to cause a polarization surface of a north pole and a south pole, of the autofocus displacement detection magnet to face the magnetic flux density detecting element. Therefore, sensitivity of the autofocus displacement detecting section in detection of displacement is increased. Furthermore, since a change in magnetic flux density is symmetric with respect to the direction of the optical axis, the linearity of the detection of displacement is improved.

The camera module (camera module 400, 500) in accordance with a fourth aspect of the present invention can be arranged such that: in the third aspect, the at least one drive magnet (combined magnets 41 or AF magnet 12) includes a plurality of drive magnets; the autofocus driving section (AF driving section 37) is provided to the autofocus fixed section (intermediate retaining member 13); and the magnetic flux density detecting element (21a) or the autofocus displacement detection magnet (AF displacement detection magnet 42) is provided between adjacent ones of the plurality of drive magnets.

According to the above configuration, in a case where the plurality of drive magnets are thus provided, the autofocus displacement detecting section is provided between adjacent ones of the plurality of drive magnets so as to be apart from the plurality of drive magnets. Therefore, according to the above configuration, since the autofocus displacement detecting section is provided at a position apart from the plurality of drive magnets, it is possible to reduce (i) an magnetic interference from each of the plurality of drive magnets and (ii) an effect of a magnetic field generated by the autofocus coil, and accordingly possible to achieve highly-accurate or highly-reliable detection of displacement.

The camera module (camera module 400, 500) in accordance with a fifth aspect of the present invention can be arranged such that, in the fourth aspect, the magnetic flux density detecting element (21a) or the autofocus displacement detection magnet (AF displacement detection magnet 42) is provided on a line intermediate between the adjacent ones of the plurality of drive magnets (combined magnets 41 or AF magnet 12).

According to the above configuration, the magnetic flux density detecting element or the autofocus displacement detection magnet is provided on the line intermediate between the adjacent ones of the plurality of drive magnets. In each of a case where the magnetic flux density detecting element is provided on the line intermediate between the adjacent ones of the plurality of drive magnets and a case where the autofocus displacement detection magnet is provided on the line intermediate between the adjacent ones of the plurality of drive magnets, since the magnetic flux density detecting element is provided at a position apart from the plurality of drive magnets, it is possible to reduce (i) a magnetic interference from each of the plurality of drive magnets and (ii) an effect of a magnetic field generated from the autofocus coil, and accordingly possible to achieve highly-accurate or highly-reliable detection of displacement.

Note that how to provide the autofocus displacement detecting section and the plurality of drive magnets can be determined as appropriate in consideration of various conditions.

The camera module (camera module 400) in accordance with a sixth aspect of the present invention can be arranged such that: in the fourth or the fifth aspect, the autofocus fixed section (intermediate retaining member 13) has a quadrangular shape; the plurality of drive magnets (combined magnets 41 or AF magnet 12) are provided along respective sides of the autofocus fixed section; and the magnetic flux density detecting element (21a) or the autofocus displacement detection magnet (AF displacement detection magnet 42) is provided on any one of four corners of the autofocus fixed section.

According to the above configuration, it is possible to easily reduce a size of the camera module. Therefore, the above configuration is suitable for a small-sized module.

The camera module (camera module 500) in accordance with a seventh aspect of the present invention can be arranged such that: in the fourth or fifth aspect, the autofocus fixed section (intermediate retaining member 13) has a quadrangular shape; the plurality of drive magnets (combined magnets 41 or AF magnet 12) are provided on respective corners of the autofocus fixed section; and the magnetic flux density detecting element (21a) or the autofocus displacement detection magnet (AF displacement detection magnet 42) is provided on any one of four sides of the autofocus fixed section.

The above configuration is suitable for a large-sized camera module.

The camera module (camera module 100, 200, 300, 400, 500) in accordance with an eighth aspect of the present invention can be arranged such that: in any one of the first through seventh aspects, the image stabilization displacement detecting section (OIS displacement detecting section 34) is provided to the image stabilization fixed section (base 19); and the autofocus displacement detecting section (AF displacement detecting section 31) is provided to the autofocus fixed section (intermediate retaining member 13).

For example, according to the image stabilization device of Patent Literature 2, in a case where displacement of the autofocus is intended to be detected, the magnet is provided to the fixed portion (intermediate retainer) in the autofocus. Therefore, according to the technique of Patent Literature 2, in order to detect displacement of the autofocus movable section with use of, for example, a Hall element during autofocusing, it is necessary to provide the Hall element to the lens holder which is displaced during autofocusing. Therefore, wiring is needed between the lens holder and the base so as to electrify the Hall element. As a result, wiring is needed between (i) a portion which is displaced during autofocusing and (ii) a portion which is not displaced during autofocusing and between (a) a portion which is displaced during image stabilization and (b) a portion which is not displaced during image stabilization. This causes wiring to the Hall element to be complicated.

However, according to the eighth aspect, the image stabilization displacement detecting section is provided to the image stabilization fixed section. Therefore, there is no need to provide, between the image stabilization movable section and the image stabilization fixed section, wiring serving as electrifying means for electrifying the image stabilization displacement detecting section. Further, the autofocus displacement detecting section is provided to the autofocus fixed section (image stabilization movable section). Therefore, according to the camera module in accordance with the eighth aspect, although wiring serving as electrifying means for electrifying the autofocus displacement detecting section is required between the image stabilization movable section and the image stabilization fixed section, merely the wiring serving as electrifying means for electrifying the autofocus displacement detecting section is required as wiring, serving as electrifying means, necessary between the autofocus fixed section and the image stabilization fixed section. That is, the camera module in accordance with the eighth aspect merely needs minimum wiring. This simplifies wiring. It is therefore possible to realize feedback control of autofocusing and image stabilization with use of simple electrifying means, as compared with the image stabilization device of Patent Literature 2.

The camera module (camera module 100, 200, 400, 500) in accordance with a ninth aspect of the present invention can be arranged so as to, in the eight aspect, further including: at least four supports (suspension wires 16) via which the autofocus fixed section (intermediate retaining member 13) is connected to the image stabilization fixed section (base 19) and which support the autofocus fixed section so that the autofocus fixed section is displaceable in the two directions which are each perpendicular to the optical axis and which are perpendicular to each other, with respect to the image stabilization fixed section, an autofocus driving control section (AF driving control section 32), which controls driving of the autofocus driving section (AF driving section 37), being provided to the autofocus fixed section integrally with the autofocus displacement detecting section (AF displacement detecting section 31), the autofocus driving control section being electrically connected to the image stabilization fixed section via the at least four supports.

According to the above configuration, it is possible to use the at least four supports each as electrifying means. Therefore, there is no need to newly use electrifying means as electrifying means for electrifying the autofocus driving control section. This simplifies wiring. It is therefore possible to realize, with a simple configuration, feedback control of autofocusing and image stabilization.

The camera module (camera module 100, 200, 400, 500) in accordance with a tenth aspect of the present invention can be arranged so as to, in the ninth aspect, further including: an elastic supporting member (elastic body 20) which is elastically deformable in the direction of the optical axis, the at least four supports (suspension wires 16) connecting the autofocus fixed section to the image stabilization fixed section (base 19) via the elastic supporting member.

According to the above configuration, it is possible to support the autofocus fixed section by the at least four supports via the elastic supporting member. Therefore, in a case where a drop impact force acts on the elastic supporting member in a longitudinal direction of the at least four supports, the elastic supporting member is deformed so that an amount of deformation of each of the at least four supports is reduced. It is therefore possible to prevent the at least four supports from being damaged by a drop of the camera module.

The camera module (camera module 300, 400, 500) in accordance with an eleventh aspect of the present invention can be arranged so as to, in the eighth aspect, further include: a plurality of balls (guide balls 26); and a flexible printed circuit board (FPC 27), the image stabilization movable section being supported by the plurality of balls so as to be displaceable in the two directions which are each perpendicular to the optical axis and which are perpendicular to each other, with respect to the image stabilization fixed section (base 19), the autofocus driving control section (driving control section 32), which controls the driving of the autofocus driving section, being provided to the autofocus fixed section (intermediate retaining member 13), the autofocus driving control section being electrically connected to the image stabilization fixed section via the flexible printed circuit board.

According to the above configuration, it is possible to support the autofocus fixed section without use of a support. This allows a risk of damage to a support which damage is caused by a drop impact to be prevented. As a result, in a case where, for example, the image capturing lens is large in size and the image stabilization movable section is accordingly great in weight, it is possible to reduce a risk of damage to the camera module.

The camera module (camera module 100, 200, 400, 500) in accordance with a twelfth aspect of the present invention can be arranged such that, in the tenth aspect, the elastic supporting member (elastic body 20) includes a damper member (24) which reduces vibration of the elastic supporting member.

According to the above configuration, it is possible to reduce the vibration of the elastic supporting member with use of the damper member. Therefore, in a case where a drop impact force acts on the at least four supports in a longitudinal direction of the at least four supports, the damper member is deformed so that an amount of deformation of each of the at least four supports is reduced. It is therefore possible to prevent the at least four supports from being damaged by a drop of the camera module.

The camera module (camera module 100, 200, 400, 500) in accordance with a thirteenth aspect of the present invention can be arranged such that, in the twelfth aspect, the damper member (24) is provided so as to cover (i) a lower surface of the elastic supporting member (elastic body 20) and at least part of each of the at least four supports (suspension wires 16).

According to the above configuration, it is possible to suppress vibration of a root of each of the at least four supports, which root is most likely to suffer a brittle fracture, with use of the damper member. This allows a reduction in stress acting on the root. As a result, it is possible to prevent the at least four supports from being fractured in a case where stress is repeatedly applied to the at least four supports.

The camera module (camera module 100, 200, 400, 500) in accordance with a fourteenth aspect of the present invention can be arranged such that, in the thirteenth aspect, the damper member (24) is connected to the autofocus fixed section (intermediate retaining member 13).

According to the above configuration, the damper member acts so as to suppress a speed of relative displacement between the at least four supports and the autofocus fixed section. Therefore, as such, the damper member is capable of bringing about a damping effect with respect to the at least four supports.

The camera module (camera module 100, 200, 400, 500) in accordance with a fifteenth aspect of the present invention can be arranged such that, in the fourteenth aspect, the autofocus fixed section (intermediate retaining member 13) has a receiving part (13a) for facilitating application of the damper member (24).

According to the above configuration, the autofocus fixed section has the receiving part for facilitating the application of the damper member. Therefore, in a case where, for example, a gel material is used as the damper member, it is possible to prevent the damper member, which has not been cured, from flowing and adhering to a part to which the damper member does not need to be provided.

The camera module (camera module 200, 400, 500) in accordance with a sixteenth aspect of the present invention can be arranged such that: in the ninth or the tenth aspect, the image stabilization fixed section (base 19) includes a substrate (substrate part 19c) having flexible portions; and the at least four supports (suspension wires 16) are connected to the respective flexible portions.

According to the above configuration, each of the flexible portions functions as an elastic body. It is therefore possible to further suppress stress applied to each of the at least four supports.

The camera module (camera module 600) in accordance with a seventeenth aspect of the present invention can be arranged so as to, in the first or the second aspect, further including: at least four supports (suspension wires 16) via which the autofocus fixed section (intermediate retaining member 13) is connected to the image stabilization fixed section (base 19) and which support the autofocus fixed section so that the autofocus fixed section is displaceable in the two directions which are each perpendicular to the optical axis and which are perpendicular to each other, with respect to the image stabilization fixed section; and an elastic supporting member (elastic body 20) which is elastically deformable in the direction of the optical axis, the at least four supports connecting the autofocus fixed section to the image stabilization fixed section via the elastic supporting member, the autofocus displacement detecting section being fixed to one of connections (P) between the at least four supports and the elastic supporting member or to one of extended parts (arm extensions 20c) which extend from the respective connections and which are not displaced in the direction of the optical axis.

According to the above configuration, the AF displacement detecting section 31 is fixed to one of connections between the suspension wires 16 and the elastic body 20. Even in a case where disturbance vibration is applied to the connections P between the suspension wires and the elastic body, the connections P are hardly displaced unless the suspension wires are expanded or contracted. Therefore, even in a case where the disturbance vibration is applied to the connections P, the AF displacement detecting section 31, fixed to the one of the connections, is also hardly displaced unless the suspension wires 16 are expanded or contracted. As such, the AF displacement detecting section 31 can be regarded as being fixed to the base 19 (image stabilization fixed section) of the camera module 600. Therefore, in both of (i) a case where the lens holder 4 is displaced in the direction of the optical axis and (ii) a case where the intermediate retaining member 13 is displaced so that the lens holder 4 is displaced together with the intermediate retaining member 13, the AF displacement detecting section 31 is capable of accurately detecting, as an amount of displacement of the image capturing lenses 1, an amount of relative displacement of the image capturing lenses 1 with respect to the image capturing element 6. Accordingly, even in a case where the camera module 600 receives vibration having a high frequency of an order of hundreds of hertz, it is possible to (i) accurately detect an amount of displacement of the image capturing lenses 1, (ii) feed the amount of the displacement of the image capturing lenses 1 back to the autofocus driving control section, and (iii) secure a necessary servo band, thereby suppressing the vibration of the image capturing lenses 1 which vibration has been caused by disturbance vibration. As a result, it is possible to improve an image capturing quality of the camera module 600.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention can be used in a field of manufacture of a camera module. Especially, the present invention can be preferably used in a field of manufacture of a camera module which is mounted to various electronic devices including a communication device such as a mobile terminal.

### REFERENCE SIGNS LIST

1 Image capturing lens (autofocus movable section and image stabilization movable section)
2 Lens barrel (autofocus movable section and image stabilization movable section)
3 Adhesive (autofocus movable section and image stabilization movable section)
4 Lens holder (autofocus movable section and image stabilization movable section)
4a Protrusion
5 Lens drive section
6 Image capturing element
7 Substrate
8 Sensor cover
8a Opening
8b Recess
8c Protrusion
9 Glass substrate
10 Image capturing section
11 Guide ball (AF guide ball: image stabilization movable section)
12 AF magnet (autofocus movable section and image stabilization movable section)
12a Polarization line
13 Intermediate retaining member (autofocus fixed section and image stabilization movable section)
13a Receiving part
14 AF coil
15 OIS magnet (image stabilization movable section)
15a Polarization line
16 Suspension wire (support)
16a First connected part
16b Second connected part
16c Flexible part
17 Cover
17a Opening
18 OIS coil
19 Base (image stabilization fixed section)
19a Opening
19b Resin part
19c Substrate part (flexible part)
20 Elastic body (elastic supporting member: image stabilization movable section)
20a Arm part
20c Arm extension (extended part)
21 AF Hall element
21a Magnetic flux density detecting element
22 OIS Hall element
23 Adhesive
24 Damper member
25 Solder
26 Guide ball (OIS guide ball)
27 FPC (flexible printed circuit board)
30 Driver section
31 AF displacement detecting section (autofocus displacement detecting section)
32 AF driving control section (autofocus driving control section)
32a AF lens position comparing section
32b AF driving signal output section
33 Storing calculation section
34 OIS displacement detecting section (image stabilization displacement detecting section)
35 OIS driving control section (image stabilization driving control section)
35a OIS lens position comparing section
35b OIS driving signal output section
36 Storing calculation section
37 AF driving section (autofocus driving section)
38 OIS driving section (image stabilization driving section)
40 AF spring (autofocus movable section and image stabilization movable section)
41 Combined magnet (drive magnet: image stabilization movable section)
41a Polarization line
42 AF displacement detection magnet (autofocus displacement detection magnet: image stabilization movable section)
43 Hall holder
100, 200, 300, 400, 500, 600 Camera module

1. A camera module comprising:
an image stabilization fixed section including:
an image capturing element;
an image stabilization movable section including:
an image capturing lens;
an autofocus fixed section; and
an autofocus movable section;
an autofocus displacement detecting section;
an image stabilization displacement detecting section;
an image stabilization driving section; and
an autofocus driving section,
the image capturing element having an axis corresponding to an optical axis of the image capturing lens,
the image stabilization fixed section being not displaced in any direction,
the image stabilization movable section being displaced, by the image stabilization driving section, in two directions which are each perpendicular to the optical axis and which are perpendicular to each other, with respect to the image stabilization fixed section,
the autofocus fixed section being not displaced in a direction of the optical axis,
the autofocus movable section being displaced, by the autofocus driving section, in the direction of the optical axis with respect to the autofocus fixed section,
the autofocus displacement detecting section detecting displacement of the autofocus movable section in the direction of the optical axis,
the image stabilization displacement detecting section detecting displacement of the image stabilization movable section in the two directions which are each perpendicular to the optical axis and which are perpendicular to each other.

2. The camera module as set forth in claim 1, further comprising:
an autofocus driving control section which controls driving of the autofocus driving section; and
an image stabilization driving control section which controls driving of the image stabilization driving section,
the autofocus driving control section controlling the driving of the autofocus driving section by feedback control which is based on a result of detection carried out by the autofocus displacement detecting section,
the image stabilization driving control section controlling the driving of the image stabilization driving section by feedback control which is based on a result of detection carried out by the image stabilization displacement detecting section.

3. The camera module as set forth in claim 1, wherein:
the autofocus driving section includes at least one drive magnet for causing the autofocus movable section to be magnetically driven;
one of the autofocus movable section and the autofocus fixed section includes an autofocus displacement detection magnet which is provided so as to be apart from the at least one drive magnet;
the autofocus displacement detecting section includes an magnetic flux density detecting element which is provided to the other one of the autofocus movable section and the autofocus fixed section so as to be apart from the at least one drive magnet and so as to face the autofocus displacement detection magnet; and
the autofocus displacement detecting section detects the displacement of the autofocus movable section in the direction of the optical axis in accordance with a change in magnetic flux density of the autofocus displacement detection magnet which change is detected by use of the magnetic flux density detecting element.

4. The camera module as set forth in claim 3, wherein:
the at least one drive magnet includes a plurality of drive magnets;
the plurality of drive magnets are provided to the autofocus fixed section; and
the magnetic flux density detecting element or the autofocus displacement detection magnet is provided between adjacent ones of the plurality of drive magnets.

5. The camera module as set forth in claim 4, wherein the magnetic flux density detecting element or the autofocus displacement detection magnet is provided on a line intermediate between the adjacent ones of the plurality of drive magnets.

6. The camera module as set forth in claim 4, wherein:
the autofocus fixed section has a quadrangular shape, when viewed from above;
the plurality of drive magnets are provided along respective sides of the autofocus fixed section, when viewed from above; and
the magnetic flux density detecting element or the autofocus displacement detection magnet is provided on any one of four corners of the autofocus fixed section.

7. The camera module as set forth in claim 4, wherein:
the autofocus fixed section has a quadrangular shape, when viewed from above;
the plurality of drive magnets are provided on respective corners of the autofocus fixed section, when viewed from above; and
the magnetic flux density detecting element or the autofocus displacement detection magnet is provided on any one of four sides of the autofocus fixed section.

8. The camera module as set forth in claim 1, wherein:
the image stabilization displacement detecting section is provided to the image stabilization fixed section; and
the autofocus displacement detecting section is provided to the autofocus fixed section.

9. The camera module as set forth in claim 8, further comprising:
at least four supports via which the autofocus fixed section is connected to the image stabilization fixed section and which support the autofocus fixed section so that the autofocus fixed section is displaceable in the two directions which are each perpendicular to the optical axis and which are perpendicular to each other, with respect to the image stabilization fixed section; and
an autofocus driving control section which controls driving of the autofocus driving section, the autofocus driving control section being provided to the autofocus fixed section integrally with the autofocus displacement detecting section,
the autofocus driving control section being electrically connected to the image stabilization fixed section via the at least four supports.

10. The camera module as set forth in claim 9, further comprising:
an elastic supporting member which is elastically deformable in the direction of the optical axis,
the at least four supports connecting the autofocus fixed section to the image stabilization fixed section via the elastic supporting member.

11. The camera module as set forth in claim 1, further comprising:
at least four supports via which the autofocus fixed section is connected to the image stabilization fixed section and which support the autofocus fixed section so that the autofocus fixed section is displaceable in the two directions which are each perpendicular to the optical axis and which are perpendicular to each other, with respect to the image stabilization fixed section; and
an elastic supporting member which is elastically deformable in the direction of the optical axis,
the at least four supports connecting the autofocus fixed section to the image stabilization fixed section via the elastic supporting member,
the autofocus displacement detecting section being fixed to one of connections between the at least four supports and the elastic supporting member or to one of extended parts which extend from the respective connections and which are not displaced in the direction of the optical axis.

12. The camera module as set forth in claim 8, further comprising:
an autofocus driving control section which controls driving of the autofocus driving section, the autofocus driving control section being provided to the autofocus fixed section;
a plurality of balls; and
a flexible printed circuit board,
the image stabilization movable section being supported by the plurality of balls so as to be displaceable in the two directions which are each perpendicular to the optical axis and which are perpendicular to each other, with respect to the image stabilization fixed section,
the autofocus driving control section being electrically connected to the image stabilization fixed section via the flexible printed circuit board.

13. The camera module as set forth in claim 10, wherein the elastic supporting member includes a damper member which reduces vibration of the elastic supporting member.

14. The camera module as set forth in claim 13, wherein the damper member is provided so as to cover (i) a lower surface of the elastic supporting member and at least part of each of the at least four supports.

15. The camera module as set forth in claim 14, wherein the damper member is connected to the autofocus fixed section.

16. The camera module as set forth in claim 15, wherein the autofocus fixed section has a receiving part for facilitating application of the damper member.

17. The camera module as set forth in claim 9, wherein:
the image stabilization fixed section includes a substrate having flexible portions; and
the at least four supports are connected to the respective flexible portions.

18. The camera module as set forth in claim 1, further comprising:
at least four supports via which the autofocus fixed section is connected to the image stabilization fixed section and which support the autofocus fixed section so that the autofocus fixed section is displaceable in the two directions which are each perpendicular to the optical axis and which are perpendicular to each other, with respect to the image stabilization fixed section; and
an elastic supporting member which is elastically deformable in the direction of the optical axis,
the at least four supports connecting the autofocus fixed section to the image stabilization fixed section via the elastic supporting member,
the elastic supporting member including a damper member which reduces vibration of the elastic supporting member.
